(19) United States
(12) Patent Application Publication
(10) Pub. No.: US 2022/0164717 A1
(43) Pub. Date: May 26, 2022

(54) RESOURCE MANAGEMENT SYSTEM, COMMUNICATION TERMINAL, AND RECORDING MEDIUM

(71) Applicant: Naru NAKAMURA, Kanagawa (JP)

(72) Inventor: Naru NAKAMURA, Kanagawa (JP)

(21) Appl. No.: 17/533,121

(22) Filed: Nov. 23, 2021

(30) Foreign Application Priority Data
Nov. 25, 2020 (JP) 2020-195519

(51) Int. Cl. G06Q 10/02

(52) U.S. Cl. CPC G06Q 10/02

(57) ABSTRACT

A resource management system includes a resource management apparatus that manages usage of a plurality of resources; and a communication terminal. The resource management apparatus stores, in a storage, map information of an area in which each resource is arranged; and transmits, to the communication terminal, the map information of the area associated with a resource for which a usage start request to start using the resource has been made, in response to accepting the usage start request from the communication terminal. The communication terminal displays a screen by switching from a resource list display screen on which state information indicating a usage state of the resource and reservation information of the resource are displayed, to a map information screen on which the received map information of the area associated with the resource for which the usage start request has been made is displayed.

### CROSS-REFERENCE TO RELATED APPLICATION

The present application is based on and claims priority under 35 U.S.C. § 119 to Japanese Patent Application No. 2020-195519, filed on Nov. 25, 2020, the contents of which are incorporated herein by reference in their entirety.

### BACKGROUND OF THE INVENTION

### 1. Field of the Invention

The present invention relates to a resource management system, a communication terminal, and a recording medium.

### 2. Description of the Related Art

A technology is known in which an information processing terminal located in a conference room displays information relating to the reservation of a resource such as the conference room. This enables a user to input the start of use into the information processing terminal when the user starts using the conference room, and to input the end of use into the information processing terminal when the user finishes using the conference room.

Further, there is a conference room reservation system including a management server, an operation terminal, a terminal in front of each room, and a general information terminal. In this conference room reservation system, the reservation status of each conference room may be indicated by any of the three states of “in use”, “reserved”, and “vacant”, which are displayed on the general information screen of the general information terminal (see Patent Document 1).

Patent Document 1: Japanese Unexamined Patent Application Publication No. 2016-004511

### SUMMARY OF THE INVENTION

According to one aspect of the present invention, there is provided a resource management system including a resource management apparatus configured to manage usage of a plurality of resources; and a communication terminal, wherein the resource management apparatus includes first circuitry; and a first memory storing computer-executable instructions that cause the first circuitry to execute storing, in a storage, map information of an area in which each of the plurality of resources is arranged; and transmitting, to the communication terminal, the map information of the area associated with a resource for which a usage start request to start using the resource has been made among the plurality of resources, in response to accepting the usage start request from the communication terminal, and wherein the communication terminal includes second circuitry; and a second memory storing computer-executable instructions that cause the second circuitry to execute displaying a screen by switching from a resource list display screen on which state information indicating a usage state of at least one resource among the plurality of resources and reservation information of the at least one resource are displayed, to a map information screen on which the map information of the area associated with the resource for which the usage start request has been made is displayed, the map information being transmitted from the resource management apparatus.

### BRIEF DESCRIPTION OF THE DRAWINGS

FIG. 1 is a diagram illustrating an example of the overall configuration of a resource management system according to an embodiment of the present invention;

FIG. 2 is a diagram illustrating an example of a hardware configuration of a reservation management server, a resource management server, and a personal computer according to an embodiment of the present invention;

FIG. 3 is a diagram illustrating an example of the hardware configuration of a reception terminal according to an embodiment of the present invention;

FIG. 4 is a diagram illustrating an example of a functional configuration of the resource management system according to an embodiment of the present invention;

FIG. 5 is a conceptual diagram illustrating an example of a reservation information management table according to an embodiment of the present invention;

FIG. 6A is a conceptual diagram illustrating an example of a login information table according to an embodiment of the present invention;

FIG. 6B is a conceptual diagram illustrating an example of a resource state management table according to an embodiment of the present invention;

FIG. 6C is a conceptual diagram illustrating an example of a resource identification management table according to an embodiment of the present invention;

FIG. 7 is a conceptual diagram illustrating an example of a resource group management table according to an embodiment of the present invention;

FIG. 8A is a conceptual diagram illustrating an example of a per-resource reservation management table according to an embodiment of the present invention;

FIG. 8B is a conceptual diagram illustrating an example of a map information management table according to an embodiment of the present invention;

FIG. 9 is a conceptual diagram illustrating an example of a mark management table according to an embodiment of the present invention;

FIG. 10 is a sequence diagram illustrating an example of an activation process in coordination registration of a conference room map according to an embodiment of the present invention;

FIG. 11 is a sequence diagram illustrating an example of floor map image registration in coordination registration of a conference room map according to an embodiment of the present invention;

FIG. 12 is a sequence diagram illustrating an example of resource position registration in coordination registration of a conference room map according to an embodiment of the present invention;

FIG. 13 is a sequence diagram illustrating an example of resource floor number registration in coordination registration of a conference room map according to an embodiment of the present invention;

FIG. 14 is a diagram illustrating an example of the login screen at the time of activation according to an embodiment of the present invention;

FIG. 15 is a diagram illustrating an example of a group management screen according to an embodiment of the present invention;

FIG. 16 is a diagram illustrating an example of a group registration screen according to an embodiment of the present invention;

FIG. 17 is a diagram illustrating an example of a floor map for registration according to an embodiment of the present invention;

FIG. 18 is a diagram illustrating an example of coordinate setting on a floor map according to an embodiment of the present invention;

FIG. 19 is a sequence diagram illustrating an example for displaying a floor map on the reception terminal according to an embodiment of the present invention;

FIG. 20 is a diagram illustrating an example of the resource list display screen according to an embodiment of the present invention;

FIG. 21 is a diagram illustrating an example of a floor map display screen (A) after switching according to an embodiment of the present invention; and

FIG. 22 is a diagram illustrating an example of the floor map display screen (B) after switching according to an embodiment of the present invention.

### DESCRIPTION OF THE EMBODIMENTS

In Patent Document 1, the name and the usage state of a resource can be displayed on the communication terminal, which displays a list of the reservations and the usage states of a plurality of conference rooms which are examples of a plurality of resources. However, the position of the resource is not displayed. Therefore, it has been difficult for a user of the resource to identify where the target resource is located for starting to use the resource, by referring to a communication terminal that displays a list of the usage states of a plurality of resources.

A problem to be addressed by an embodiment of the present invention is to enable the position of a resource to be easily identified.

Hereinafter, embodiments for carrying out the present invention will be described with reference to the drawings. In the description of the drawings, the same elements are denoted by the same reference numerals, and overlapping descriptions are omitted.

### [Overview of Resource Management System]

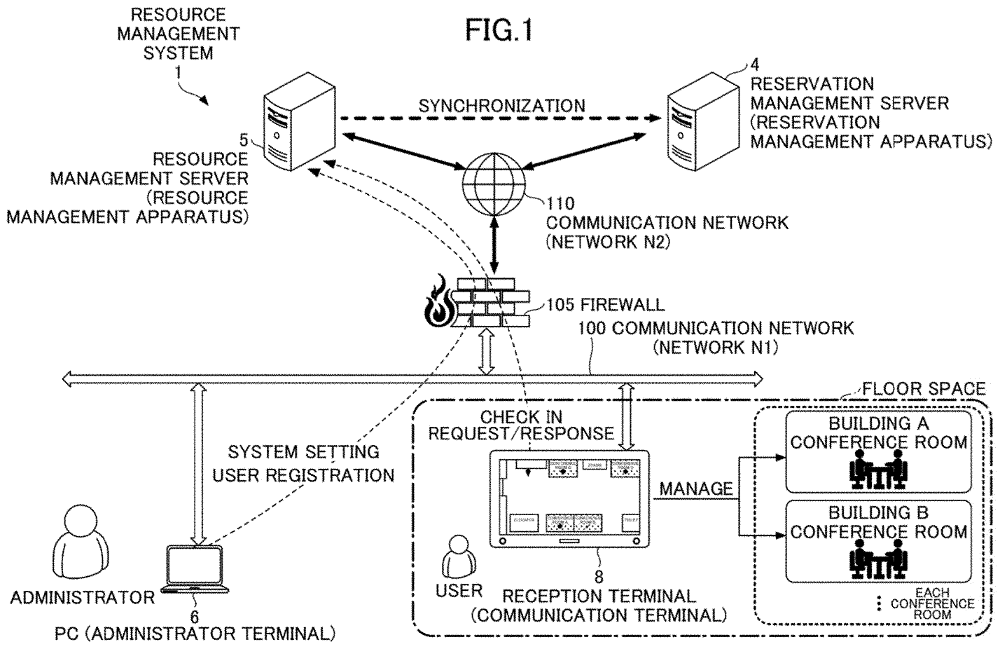

FIG. 1 is a diagram illustrating an example of the overall configuration of a resource management system. In a resource management system 1 illustrated in FIG. 1, a floor map of resources is uploaded to a resource management server 5 from a personal computer (PC) 6 used by an administrator of the resource, and position information and floor number information are provided in the floor map. Subsequently, the resource management server 5 transmits the floor map provided with the position information and the floor number information, the usage state of each resource, and the reservation information relating to each resource, to a reception terminal 8 installed in the space where the resource is located. When the user of the resource who has looked at the reception terminal 8 starts using the resource to be used, the reception terminal 8 displays map information corresponding to the area associated with the resource that the user has started using. This system makes it possible to easily identify the position of the resource to be used. According to the present embodiment, the administrator means the system administrator of a system department that manages, for example, a conference room, of a customer such as a company that uses the resource management system 1.

### <Example of System Configuration>

The resource management system 1 includes a reservation management server 4, the resource management server 5, the PC 6, and the reception terminal 8. The PC 6 and the reception terminal 8 are connected to each other via a communication network 100 (network N1), such as an in-house network, inside a firewall 105. The reservation management server 4 and the resource management server 5 are connected to each other via a communication network 110 (network N2) outside the firewall 105. The communication network 110 is a network in which an unspecified number of communications are transmitted and is configured by the Internet, a mobile communication network, a local area network (LAN), or the like. The communication network 110 may include wireless communication networks such as 3rd Generation (3G), 4th Generation (4G), 5th Generation (5G), Worldwide Interoperability for Microwave Access (WiMAX), or Long Term Evolution (LTE), as well as wired communication.

### <<Reservation Management Server>>

The reservation management server 4 is implemented by one or more information processing apparatuses (computer systems) in which a typical server operating system (OS) or the like is installed. A system relating to the reservations of resources and the management of reservations or scheduled events of a user provided by the reservation management server 4 is referred to herein as a reservation management system. The reservation management server 4 has a calendar system and provides a web application for managing various schedules of a user. For example, the reservation management server 4 has the following functions.

Registration of the users' reservations and scheduled event can be accepted, and the reservation status and the scheduled event of the user can be confirmed at anytime and anywhere.

Send a report to the user by e-mail at a set date and time such as 30 minutes prior to the scheduled event.

One person can manage reservations or scheduled events by multiple calendars (for work, for home, or the like).

Share a calendar with people in the same group.

The reservation management server 4 manages a user by an account. An account is a user's right to use a service. In many systems, the user logs into the system by using an account. For this reason, the account has a function of uniquely identifying the user by the system (identification information function). According to the present embodiment, the reservation management server 4 transmits the reservation information of a previously registered account (domain) to the conference management server that manages conference rooms or the like. Alternatively, by specifying the account of the reservation management server 4 and requesting the reservation information by the conference management server, the conference management server may acquire the reservation information of the conference room from the reservation management server 4. The account may be any information by which a user can be uniquely identified, e.g., an e-mail, an ID, a phone number, or the like.

In the present embodiment, the reservation management server 4 can manage reservation information indicating the reservations of various resources, including freely-usable spaces and conference rooms, and can manage user schedules. As the reservation management system, G Suite (registered trademark), Office 365 (registered trademark), or the like are known, but the reservation management system having the function described in the present embodiment is sufficient.

Further, in the present embodiment, information relating to various resources reserved by each user and the schedule of each user is pre-registered in the reservation management server 4. That is, the web application of the reservation management server 4 is customized according to the name of each conference room, the conference room ID, the reservation available time, the capacity of each conference room, the reservation unit, and the like, in the in-house network using the resource management system 1. Accordingly, the reservation information is associated with the resources including each conference room of the company using the resource management system 1. In the present embodiment, the reservation management server 4 functions as an example of a reservation management apparatus.

### <<Resource Management Server>>

The resource management server 5 can be implemented by one or more information processing apparatuses (computer systems) in which a typical server OS or the like is installed. As processing related to the communication network 110 (network N2), the resource management server 5 acquires the reservation information of each conference room and the expected participant set in the reservation information from the reservation management server 4, and transmits a report to a group of a chat server (or an individual person such as a reservation person, i.e. a person who makes the reservation) associated with the expected participant at a set timing. Further, as the processing related to the communication network 100 (network N1), check-in and check-out to and from each conference room are managed, and the power supply or the like of the electronic device installed in each conference room is controlled based on the reservation information of each conference room obtained from the reservation management server 4. In the present embodiment, the resource management server 5 functions as an example of the resource management apparatus.

The communication network 100 includes conference rooms in the floor space, workplaces for expected participants, and workplaces for administrators, and expected participants can access the communication network 110 via the communication network 100 and the firewall 105 from each location. The communication network 100 is, for example, a local area network (LAN). However, the conference rooms, workplaces for expected participants, and workplaces for administrators are not necessarily in the LAN within the same company.

The information shared by the resource management server 5 may not be limited to text, and may be information such as images, videos, audio, and the like. However, for the sake of convenience, it is described that text is mainly used for the reporting in the present embodiment. However, the chat system may provide a voice communication function between groups. A voice call may be one-to-one or one-to-N (≥2). Accordingly, in the present embodiment, when the chat system reports the information relating to the reservation of a resource, the chat system may output an audio message in addition to displaying text. As a chat system, LINE (registered trademark), Slack, Microsoft Teams (registered trademark), or the like are known. However, it is sufficient if the chat system is capable of reporting to one or more users of the bot (program that performs predetermined processing).

The resource management server 5 similarly manages a user with an account different from the account of the reservation management server 4, but the conference management server described above does not have to be aware of the account of the resource management server 5, in principle. However, the conference management server can send reports by specifying any account of the resource management server 5.

### <<PC>>

The administrator who manages the user's scheduled events and the like may also use the PC 6 connectable to the communication network 100 inside the firewall 105. The PC 6 is a communication terminal by which an administrator can make various settings related to resources (conference rooms) via a web page provided by the resource management server 5. One of these settings is an initial setting. A terminal device such as a smartphone belonging to the administrator may be used for making the initial setting. The PC 6 is capable of communicating in both wired and wireless manners. A chat application is installed on the PC 6 in the same manner as the reception terminal 8. Therefore, the PC 6 is used as a display terminal for confirming the reservation status and the like of resources such as a conference room including a freely-usable space reserved by the user. Further, the PC 6 may have a function of communicating by using browser software and displaying web pages.

For example, a communication terminal having a communication function such as a tablet terminal, a Personal Digital Assistant (PDA), a wearable PC (sunglasses type, wristwatch type, or the like) may be used in place of the PC 6. That is, a terminal capable of operating software such as browser software is used as a communication terminal. In the present embodiment, the PC 6 functions as an example of an administrator terminal.

### <<Reception Terminal>>

The reception terminal 8 is a communication terminal in which a typical OS or the like is installed. The reception terminal 8 may be replaced by a communication terminal having communication functions such as a tablet terminal, a PC, a PDA, a wearable PC (sunglasses type, wristwatch type, or the like. That is, a terminal capable of operating software such as browser software is used as a communication terminal.

As an example, exclusive-use application software (hereinafter, referred to as a “chat application”) that can be used between the reception terminal 8 and the resource management server 5 is installed in the reception terminal 8. Therefore, by operating the reception terminal 8 having the chat application installed therein, the user can reserve a freely-usable space or the like according to the present embodiment. According to the present embodiment, the resource management system 1 may include the conference management server for operating the application software (hereinafter, a conference application) related to the conference. Note that that the above-described application may be substituted by browser software. In the present embodiment, the reception terminal 8 functions as an example of the communication terminal.

### Terms

“Resources” refer to resources owned, leased, or managed by certain companies, groups, organizations, or the like. Resources of companies, groups, organizations, or the like may include, for example, conference rooms, usable items in the conference rooms, devices, persons (reception groups), or the like. Further, freely-usable spaces with free addresses (hereinafter simply referred to as freely-usable spaces), locations of desks, chairs, booths, or the like, company cars, bicycles, parking lots, bicycle parking spaces, remote conference systems, printing services and mechanisms, or the like may be resources. Resources that are difficult to move are referred to as facilities. In the present embodiment, the term conference room is used as an example of resources for the sake of description. Other examples of resources include various facilities such as various electronic devices, locations such as rental offices, rental studios, or the like, rental cycles, rental cars (sharing cars), lodging facilities such as hotels, event venues, rental spaces such as lockers, or the like.

A request to use a resource may be a request to use a resource for which resource identification information is required. For example, there is a start of use or a start of reservation.

Further, the user includes a person who has reserved a resource, such as a freely-usable space, a conference room, or the like, and an administrator who manages the resource management system 1 according to the present embodiment. In other words, if a person who has reserved a predetermined resource uses the resource, the person who has reserved the resource becomes the user.

### [Hardware Configuration]

### <Hardware Configuration of Reservation Management Server, Resource Management Server, and Administrator Terminal>

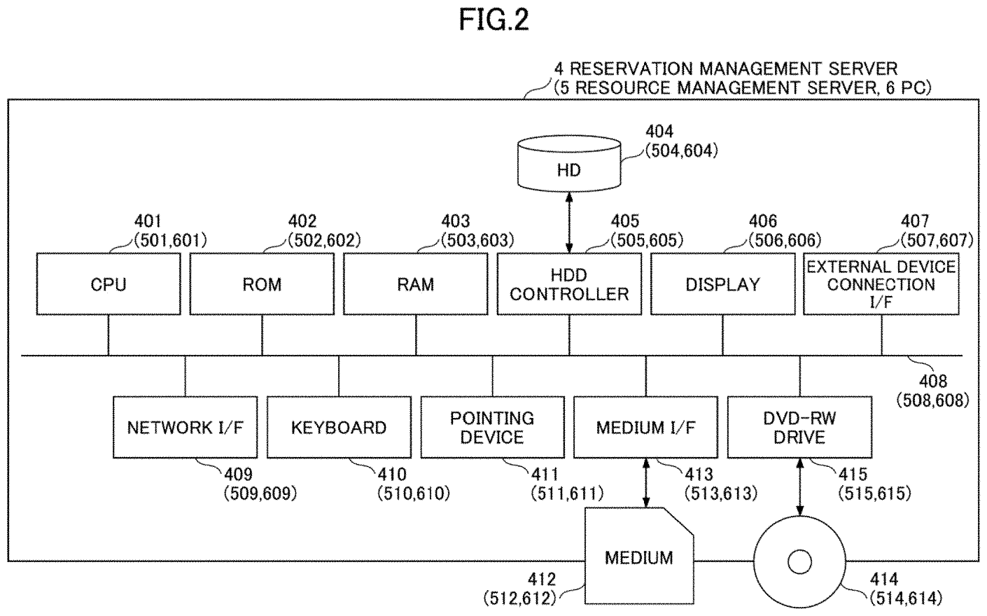

FIG. 2 is a diagram illustrating an example of a hardware configuration of a reservation management server, a resource management server, and a PC according to the first embodiment. The reservation management server 4, the resource management server 5, and the PC 6 are implemented, for example, by a computer system having the hardware configuration illustrated in FIG. 2.

The computer system illustrated in FIG. 2 is configured by a computer and includes a central processing unit (CPU) 401, a read-only memory (ROM) 402, a random access memory (RAM) 403, a hard drive (HD) 404, a hard disk drive (HDD) controller 405, a display 406, an external device connection interface (I/F) 407, a bus line 408, a network I/F 409, a keyboard 410, a pointing device 411, a medium I/F 413, and a Digital Versatile Disc Rewritable (DVD-RW) drive 415.

Among these, the CPU 401 controls the operations of the entire computer system. The ROM 402 stores a program used to drive the CPU 401, such as an initial program loader (IPL). The RAM 403 is used as the work area of the CPU 401. The HD 404 stores various kinds of data such as a program. The HDD controller 405 controls the reading or writing of various kinds of data from or to the HD 404 in accordance with the control of the CPU 401. The display 406 displays various kinds of information such as cursors, menus, windows, characters, or images. The external device connection I/F 407 is an interface for connecting various external devices. In this case, the external device may be, for example, a Universal Serial Bus (USB) memory or a printer. The network I/F 409 is an interface for performing data communication by using the communication network 110. The bus line 408 is an address bus, a data bus, or the like for electrically connecting the elements such as the CPU 401 illustrated in FIG. 2.

The keyboard 410 is a type of input means having a plurality of keys for inputting characters, numbers, various instructions, and the like. The pointing device 411 is a type of input means for selecting and executing various instructions, selecting a processing target, moving a cursor, and the like. The medium I/F 413 controls the reading or writing (storage) of data from or to a recording medium 412, such as a flash memory. The DVD-RW drive 415 controls the reading or writing of various kinds of data from or to the DVD-RW drive 415 as an example of a removable storage medium. The medium is not limited to a DVD-RW, but may be a Digital Versatile Disc Recordable (DVD-R), or the like

The resource management server 5 is configured by a computer and includes a CPU 501, a ROM 502, a RAM 503, an HD 504, an HDD controller 505, a display 506, an external device connection I/F 507, a bus line 508, a network I/F 509, a keyboard 510, a pointing device 511, a medium I/F 513, and a DVD-RW drive 514 as illustrated in FIG. 2. These have similar configurations as the CPU 401, the ROM 402, the RAM 403, the HD 404, the HDD controller 405, the display 406, the external device connection I/F 407, the bus line 408, the network I/F 409, the keyboard 410, the pointing device 411, the medium I/F 413, and the DVD-RW drive 415 in the reservation management server 4. Therefore, the descriptions thereof will be omitted.

The PC 6 is configured by a computer as described above and includes a CPU 601, a ROM 602, a RAM 603, an HD 604, an HDD controller 605, a display 606, an external device connection I/F 607, a bus line 608, a network I/F 609, a keyboard 610, a pointing device 611, a medium I/F 613, and a DVD-RW drive 614 as illustrated in FIG. 2. These have similar configurations as the CPU 401, the ROM 402, the RAM 403, the HD 404, the HDD controller 405, the display 406, the external device connection I/F 407, the bus line 408, the network I/F 409, the keyboard 410, the pointing device 411, the medium I/F 413, and the DVD-RW drive 415 in the reservation management server 4. Therefore, the description thereof will be omitted.

### <Hardware Configuration of the Reception Terminal 8>

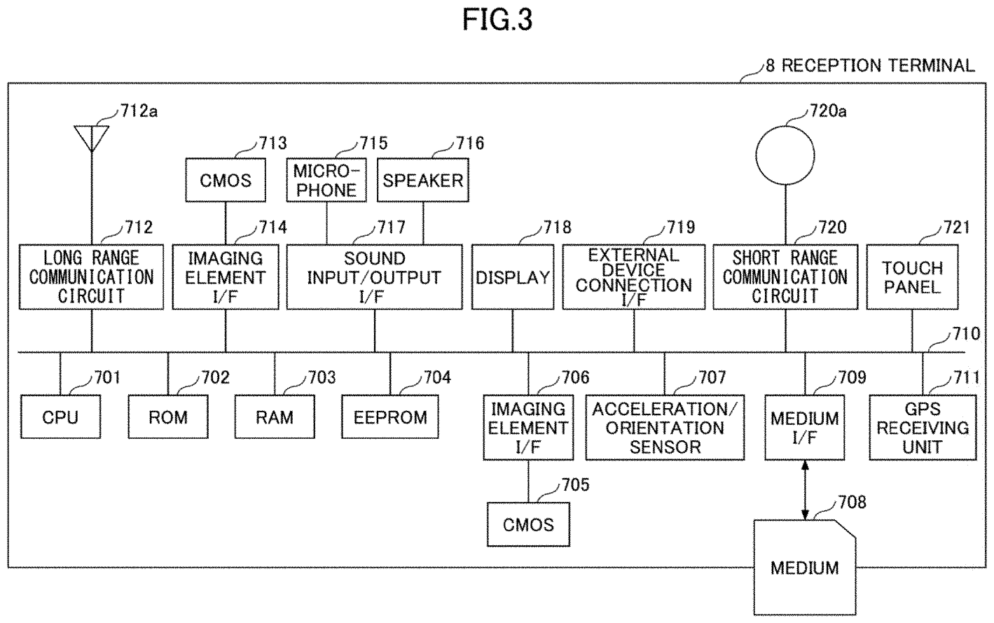

FIG. 3 is a diagram illustrating an example of the hardware configuration of the reception terminal according to the first embodiment. The reception terminal 8 includes a CPU 701, a ROM 702, a RAM 703, an EEPROM 704, a Complementary Metal Oxide Semiconductor (CMOS) sensor 705, an imaging element I/F 706, an acceleration/orientation sensor 707, a medium I/F 709, and a global positioning system (GPS) receiving unit 711.

Among these, the CPU 701 controls the overall operation of the reception terminal 8. The ROM 702 stores programs used to drive the CPU 701, such as an IPL. The RAM 703 is used as the work area of the CPU 701. The EEPROM 704 reads or writes various kinds of data of applications and the like, according to the control of the CPU 701. The CMOS sensor 705 is a type of built-in imaging means that captures a subject according to the control of the CPU 701 to obtain image data or video data. The imaging means may be a Charge Coupled Device (CCD) sensor, instead of a CMOS sensor. The imaging element I/F 706 is a circuit that controls the drive of the CMOS sensor 705. The acceleration/orientation sensor 707 includes a variety of sensors, such as an electromagnetic compass which detects geomagnetic fields, a gyrocompass, and an acceleration sensor. The medium I/F 709 controls the reading or writing (storage) of data from or to a recording medium 708, such as a flash memory. The GPS receiving unit 711 receives the GPS signal from the GPS satellite.

The reception terminal 8 includes a long range communication circuit 712, an antenna 712a of the long range communication circuit 712, a CMOS sensor 713, an imaging element I/F 714, a microphone 715, a speaker 716, a sound input/output I/F 717, a display 718, an external device connection I/F 719, a short range communication circuit 720, an antenna 720a of the short range communication circuit 720, and a touch panel 721.

Among these, the long range communication circuit 712 is a circuit for communicating with other devices via the communication network 100. The CMOS sensor 713 is a type of built-in imaging means that captures a subject according to the control of the CPU 701 to obtain image data. The imaging element I/F 714 is a circuit that controls the drive of the CMOS sensor 713. The microphone 715 is a built-in circuit that converts sound to an electrical signal, acquires voice and sound waves emitted from an external speaker, and acquires information using an electrical signal. The speaker 716 is a built-in circuit that converts electrical signals into physical vibrations to produce sound, such as music and voice sound. The sound input/output I/F 717 is a circuit that processes the input and output of sound signals between the microphone 715 and the speaker 716 according to the control of the CPU 701. The display 718 is a type of display means such as a liquid crystal display or an organic Electro Luminescent (EL) display for displaying an image of a subject or various icons. The external device connection I/F 719 is an interface for connecting various external devices. The short range communication circuit 720 is a communication circuit such as a Near Field Communication (NFC) or Bluetooth (registered trademark). The touch panel 721 is a type of input means used for operating the reception terminal 8, by pressing operations, clicking operations, tapping operations, or the like by a user with respect to the display 718. The imaging means, such as the CMOS sensor 713, the short range communication means, such as the short range communication circuit 720, the voice input means, such as the microphone 715, and the like are information acquiring means for acquiring identification information of a resource, for example, by an image such as an image code, by wireless communication, or by sound waves.

The reception terminal 8 includes a bus line 710. The bus line 710 is an address bus, a data bus, or the like for electrically connecting elements such as the CPU 701 illustrated in FIG. 3.

### [Functional Configuration of Resource Management System]

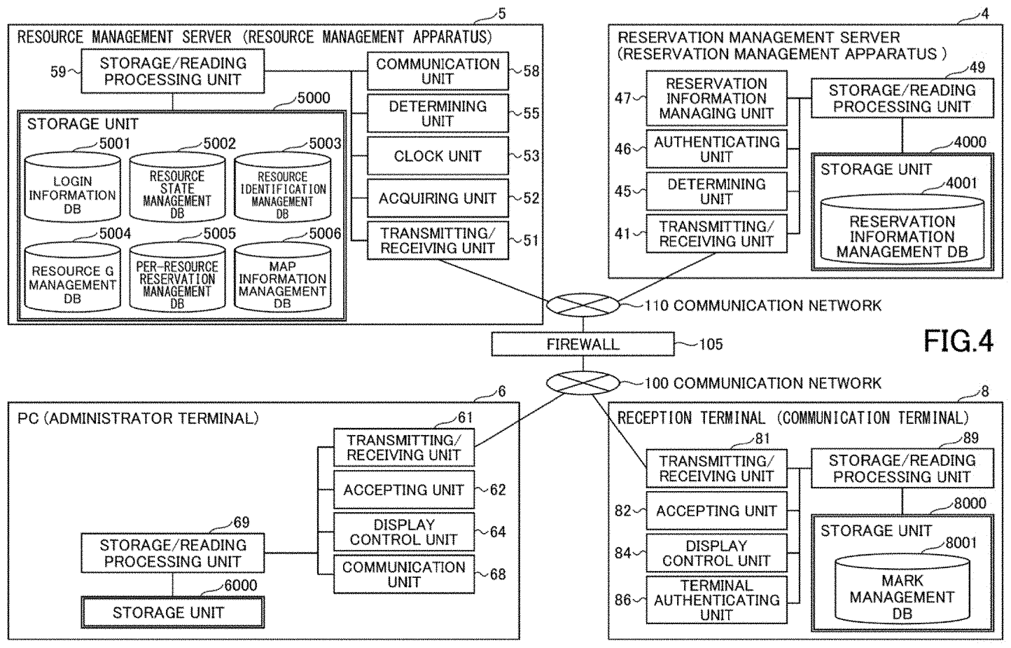

Next, the functional configuration of the present embodiment will be described with reference to FIGS. 4 to 9. FIG. 4 is a diagram illustrating an example of a functional configuration of a resource management system in accordance with the first embodiment.

### <Functional Configuration of Reservation Management Server>

As illustrated in FIG. 4, the reservation management server 4 includes a transmitting/receiving unit 41, a determining unit 45, an authenticating unit 46, a reservation information managing unit 47, and a storage/reading processing unit 49. Each of these units is a function or means that is implemented by operating any of the elements illustrated in FIG. 3 by an instruction from the CPU 401 according to a program for the reservation management server 4 loaded in the RAM 403 from at least one of the ROM 402 or the HD 404.

The reservation management server 4 includes a storage unit 4000 configured by the ROM 402 or the HD 404 illustrated in FIG. 3.

### (Reservation Information Management Table)

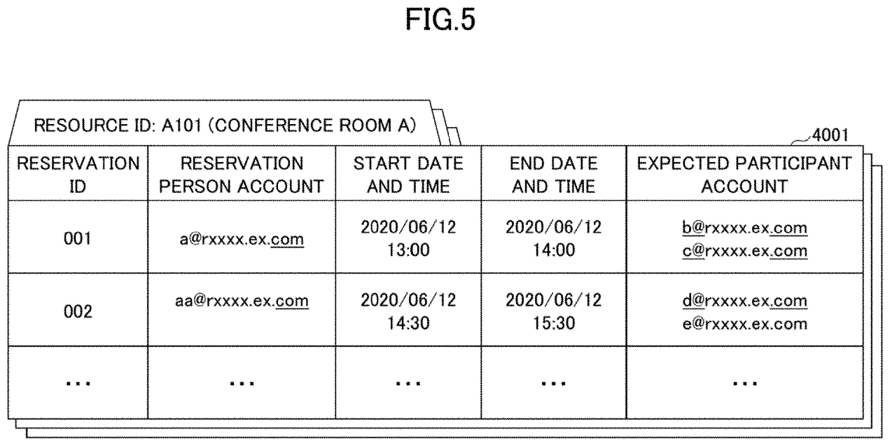

FIG. 5 is a conceptual diagram illustrating an example of a reservation information management table. A reservation information management DB 4001 configured with a reservation information management table such as that illustrated in FIG. 5 is configured in the storage unit 4000. In this reservation information management table, a tab is applied to a resource ID indicating the identification information of a resource, and for each reservation ID separated in each tab, the reservation person account, the start date and time, the end date and time, and the expected participant accounts are stored and managed in association with each other. The resource ID to which the tab is applied is, for example, A101 (conference room A).

Among these, the reservation ID is identification information that identifies one record of the reservation information. ID stands for Identification, meaning an identifier or identification information. An ID is a name, a code, a character string, a numeric value, or a combination of one or more of these items, used to uniquely distinguish a specific target among multiple targets.

A reservation person account indicates the account of the reservation person who has reserved the resource, and is, for example, an e-mail address as indicated by a@rxxxx.ex.com. The start date and time corresponds to when the reservation content starts (the date and time when the reservation content starts), and the end date and time corresponds to when the reservation content ends (the date and time when the reservation content ends). An expected participant account indicates an account of a person, an organization, or the like, that is scheduled to participate in an event that is to be held in the resource reserved by the reservation person. The expected participant account is, for example, an email address indicated by b@rxxxx.ex.com.

### <<Each Functional Configuration of Reservation Management Server>>

Next, each functional configuration of the reservation management server 4 will be described in detail. The transmitting/receiving unit 41 of the reservation management server 4 illustrated in FIG. 4 is mainly implemented by processing by the CPU 401, the external device connection I/F 407, and the network I/F 409 illustrated in FIG. 2, and performs transmission and reception of various kinds of data (or information) with the resource management server 5 via the communication network 110 configured outside the firewall 105. The transmitting/receiving unit 41 receives a login authentication request and a reservation setting when the free address of the reception terminal 8 is used.

The determining unit 45 is mainly implemented by the processing by the CPU 301 illustrated in FIG. 3, and performs various determinations in the reservation management server 4.

The authenticating unit 46 is mainly implemented by the processing by the CPU 301 illustrated in FIG. 3, and authenticates the user based on the authentication information (for example, the user ID and the password) stored in the authentication information DB. The authenticating unit 46 may perform authentication according to an integrated circuit (IC) card or biometric authentication information.

The reservation information managing unit 47 is mainly implemented by the processing by the CPU 301 illustrated in FIG. 3, and manages the reservation information registered by the user. The reservation information managing unit 47 reads various kinds of reservation information from the above-described reservation information management DB 4001 and the resource reservation management DB 4003 and transmits the information that is read to the resource management server 5 via the transmitting/receiving unit 41.

The storage/reading processing unit 49 is mainly implemented by the processing by the CPU 301 illustrated in FIG. 3, and stores various kinds of data (or information) in the storage unit 4000 or reads various kinds of data (or information) from the storage unit 4000.

### <Functional Configuration of Resource Management Server>

As illustrated in FIG. 4, the resource management server 5 includes a transmitting/receiving unit 51, an acquiring unit 52, a clock unit 53, a determining unit 55, a communication unit 58, and a storage/reading processing unit 59. Each of these functional units is a function or means that is implemented by operating any of the elements illustrated in FIG. 3 by an instruction from the CPU 501 according to a program for the resource management server 5 loaded in the RAM 503 from at least one of the ROM 502 or the HD 504. The resource management server 5 includes a storage unit 5000 configured by the ROM 502 or the HD 504 illustrated in FIG. 2.

### (Login Information Table)

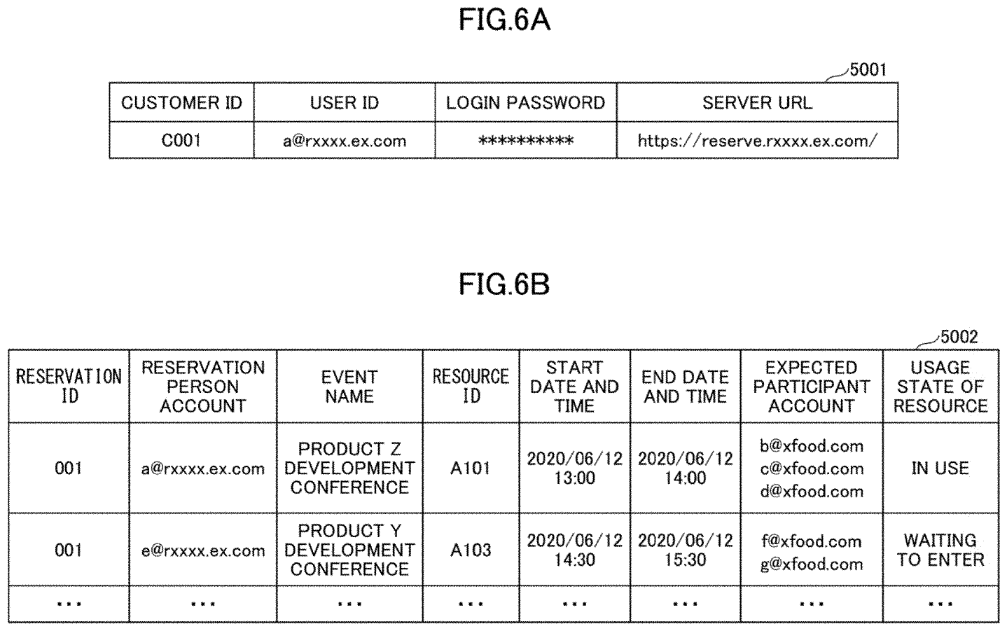

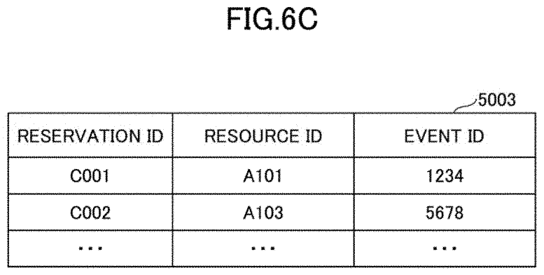

FIG. 6A is a conceptual diagram illustrating an example of a login information table. A login information DB 5001 configured with a login information table such as that illustrated in FIG. 6A is configured in the storage unit 5000. In this login information table, the user ID, the password, and the server Uniform Resource Locater (URL) are stored and managed in association with the customer ID. Among these, the customer ID is identification information corresponding to the customer such as a company or the like.

As the user ID, an e-mail address or the like of the each user managed by a customer ID, is stored and managed. When the user is successfully authenticated with respect to the resource management server 5, for example, the input user ID is considered to be correct by the resource management server 5. This user ID is the same as the account of the reservation person who has reserved the resource or the account of the participant in the various events that take place in the resource. Therefore, the resource management server 5 can identify the reservation information in which the user inputting the user ID is the reservation person or the reservation information in which the user inputting the user ID is a participant based on the input user ID.

The login password is the identification information associated with the user ID at the time of login when the resource management system 1 is used, and is set by the user at the time of the first activation (at the time of login) or the like. The server URL is the URL assigned to the customer in the resource management server 5. The server URL may be common to multiple customers.

### (Resource State Management Table)

FIG. 6B is a conceptual diagram illustrating an example of a resource state management table. A resource state management DB 5002 configured with a resource state management table such as that illustrated in FIG. 6B is configured in the storage unit 5000. In this resource status management table, for each reservation ID, the reservation person account, the event name, the resource ID, the start date and time, the end date and time, the expected participant account, and the usage state of resource are stored and managed in association with each other.

Among these, the reservation ID is identification information that identifies one record of the reservation information. The same applies to IDs below other than the reservation ID. The reservation person account is, for example, the account of the expected participant who has reserved each conference room in the floor space in the resource management system 1. The reservation person account is the account of the reservation person (expected participant) who has reserved each conference room in the floor space. The event name is the name of an event, such as a conference, which is given by an expected participant at his or her discretion. The resource ID is identification information that identifies each resource (conference room, or the like) in the in-house network. The expected participant account is the account of the expected participant who is scheduled to participate in the conference. The reservation person account and the expected participant account illustrated in FIG. 6B are both accounts issued by the reservation management server 4.

The usage state of the resource indicates the current state of the target resource. If the resource is a space such as a conference room, for example, “in use” or “waiting to enter” is the usage state. The resource usage state may be associated with the reservation status. For example, statuses such as reported information about reservation of each resource, usage validated, waiting to check in, checked in, checked out, canceled, or the like, may be registered. These usage states may be changed in association with the relationship between the current time and the start date and time and the end date and time, as well as a predetermined operation by the user (a check in process, or the like).

### (Resource Identification Management Table)

FIG. 6C is a conceptual diagram illustrating an example of a resource identification management table. A resource identification management DB 5003 configured with a resource identification management table such as that illustrated in FIG. 6C is configured in the storage unit 5000. In this resource identification management table, a resource ID and an event ID are stored and managed in association with each reservation ID.

Among these, the event ID is information for checking in to a resource, such as a conference room, in which a predetermined event takes place, and is a character, a multi-digit number, or a combination thereof, that is uniquely assigned. Check-in means starting to use a resource.

### (Resource Group Management Table)

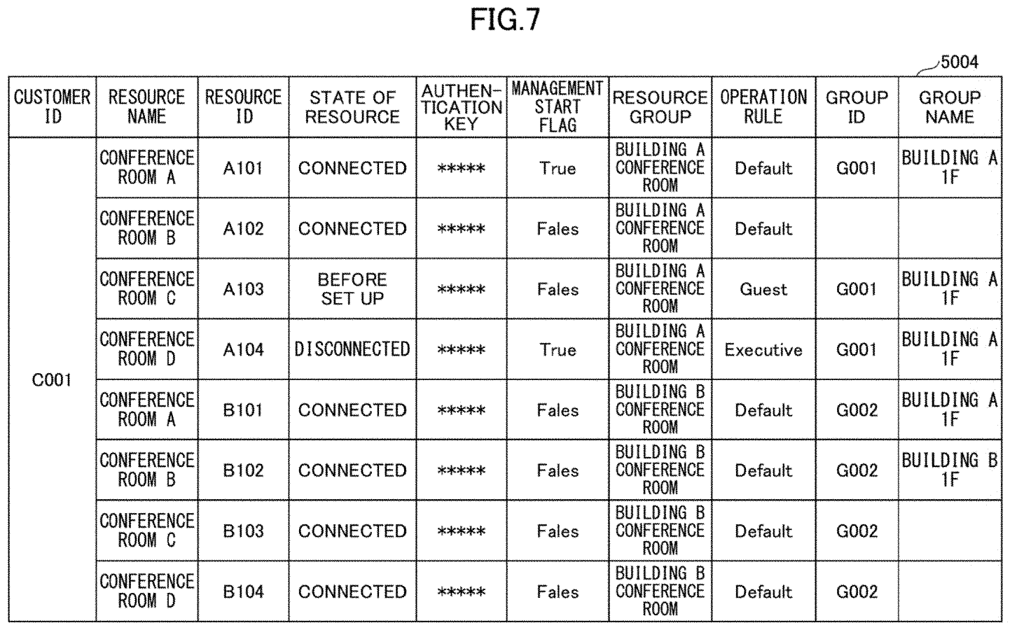

FIG. 7 is a conceptual diagram illustrating an example of a resource group management table. A resource group management DB 5004 configured with a resource group management table such as that illustrated in FIG. 7 is configured in the storage unit 5000. In this resource group management table, the resource name, the resource ID, the state of resource, the authentication key, the management start flag, the resource group, the operation rule, the group ID, and the group name are stored and managed in association with each customer ID.

Among these, the resource name is the generic name of the conference room that the participant of an event (e.g., a conference) recognizes and, for example, is displayed or presented at the entrance to the conference room.

The resource ID is identification information that uniquely identifies the conference room as described above. For simplicity, the resource ID may be common to that of the reservation management server 4. Further, by providing a conversion table, the administrator can set the resource ID separately from the reservation management server 4.

The state of the resource indicates, for example, whether the initial setting of the terminal or the reception terminal 8 installed in each conference room has been completed, whether communication is possible, or the like. For example, there are the following states.

Connected: State in which communication is confirmed within a certain period of time.

Before set up: State before making the initial setting.

Disconnected: State in which there is no communication for more than a certain period of time.

The authentication key is the authentication information for authenticating the terminal or the reception terminal 8 installed in each conference room by the resource management server 5. The authentication key is initially set to the terminal or the reception terminal 8 installed in each conference room. The authentication key is a combination of numbers, alphabetical letters, symbols, and the like that is too long to be identified by a brute-force method. The authentication key may also be determined by either the resource management server 5 or the administrator.

The management start flag is, for example, a flag indicating whether the resource management server 5 is to start the management of the conference room (True: start, False: do not start), after the initial setting of the terminal or the reception terminal 8 installed in each conference room is completed. The existence of a management start flag prevents inconveniences (reservations are cancelled automatically) caused by a time lag between the completion of the initial setting and the placement of a terminal installed in each conference room.

A resource group is, for example, an administrative group of a conference room that indicates the office or the building where the conference room is located.

An operation rule indicates which rule relating to resource operation is applied, such as the time when check in becomes possible, the time of automatic cancellation, whether automatic activation of an electronic device is required, or the like. For example, default indicates a rule for employees, guest indicates a rule for guests, and executive indicates rules for executives.

As the group ID, the identification information of a group to which the multiple resources grouped by the administrator belong, is set. For example, it can be seen that the resources (conference rooms) of building B, B101 to B104, are grouped into G002. If a resource (conference room) does not belong to a group, the group ID item is not set.

As the group name, a group name input by the administrator is set. Similar to the group ID, a group item is not set for a conference room that does not belong to a group.

Items transmitted from the reservation management server 4 may be used as the resource name, the resource ID, the management start flag (initial value: False), the resource group, and the operation rule, among the above-described items. Alternatively, the administrator may set these items in the resource management server 5. The initial state of the resource state (immediately after the provider's setting) is “before set up”, but this state changes depending on the communication status. The authentication key is set by, for example, the resource management server 5 at the time of the initial setting. The management start flag is set by the administrator. The items of the group ID are set by the resource management server 5 at the time when the administrator has grouped the resources, and the items of the group name are set by the administrator.

### (Per Resource Reservation Management Table)

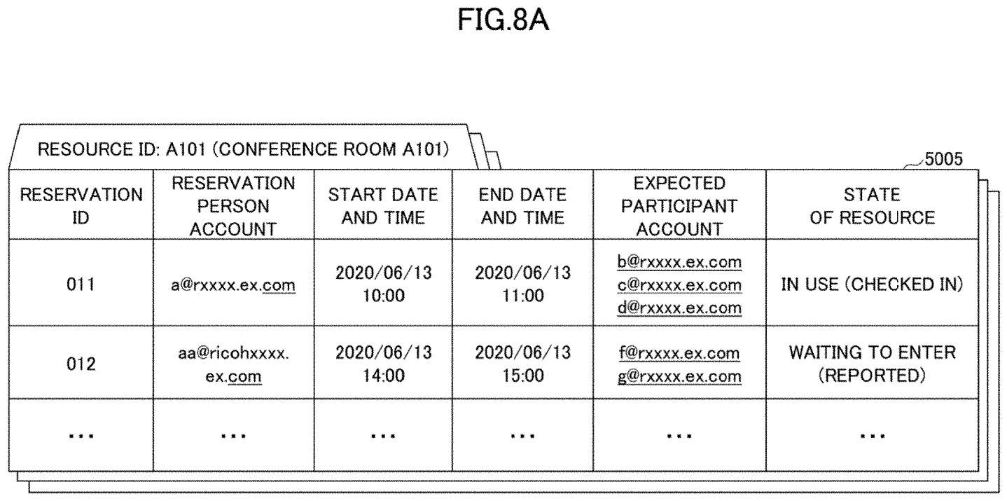

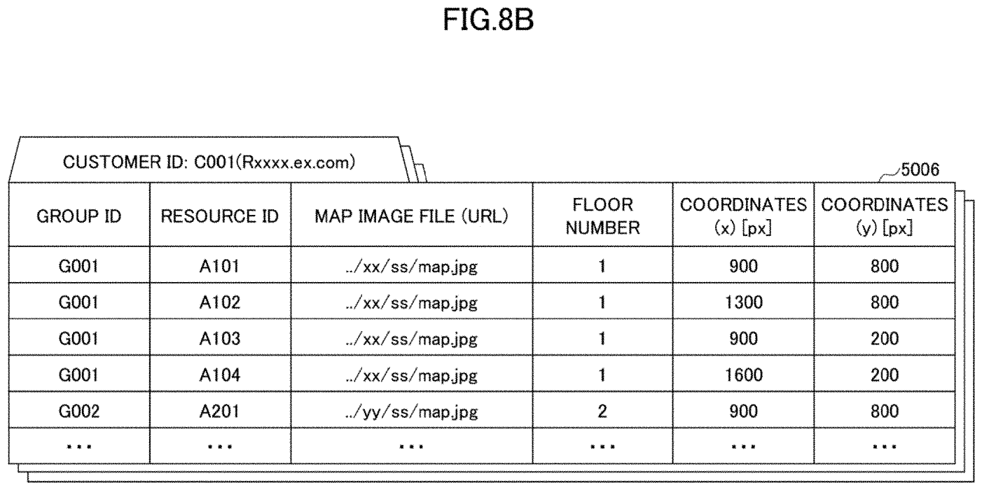

FIG. 8A is a conceptual diagram illustrating an example of a per-resource reservation management table. In the storage unit 5000, a per-resource reservation management DB 5005 configured by a per-resource reservation management table such as that illustrated in FIG. 8A is configured. In this per-resource reservation management table, a tab is applied to a resource ID, and for each reservation ID separated in each tab, the reservation person account, the start date and time, the end date and time, the expected participant account, and the resource state are stored and managed in association with each other. Among these, the state of the resource indicates the state of the resource (e.g., a conference room), such as “in use (checked in)” or “waiting to enter (reported)”.

### (Map Information Management Table)

FIG. 8B is a conceptual diagram illustrating an example of a map information management table. The map information management table such as that illustrated in FIG. 8B is generated by a coordination registration process of the conference room map, which will be described later. A map information management DB 5006 configured with a map information management table such as that illustrated in FIG. 8B is configured in the storage unit 5000. In this map information management table, a tab is applied to a customer ID, and for each group ID separated in each tab, the resource ID, the floor number, and the map image file (the URL, X coordinates, and Y coordinates) are stored and managed in association with each other. Information including any or all of these items is referred to as map information.

Among these, the map image file is indicated, for example, by the URL of the browser. This URL indicates each upload destination of image data provided in a file format such as a jpg file. That is, the URL, which is the value of the map image file, is identification information that identifies the image data.

The floor number indicates which floor number in a building the resource identified by the resource ID is located, and is information on the floor number. The floor number is an example of the area associated with each resource. This information is not limited, as long as the information can identify which area with which the resource is associated. For example, information such as a region or a zone are examples of an area.

In the present embodiment, the image data identified by the URL, which is the value of the map image file, is the image data indicating the map of the floor number in a building corresponding to the URL, in the map information management table.

The coordinates (X) and (Y) represent the distance from the origin O in the X-Y coordinate system that represents the horizontal direction (X axis) and the vertical direction (Y axis) of the map image file. For example, a pixel ([px]) is used as a unit of the distance.

That is, the X and Y coordinates in the map information management table are the position information indicating the position of the resource identified by the resource ID in the image indicating the map of the floor number in the building.

### <<Each Functional Configuration of Resource Management Server>>

Next, each functional configuration of the resource management server 5 will be described in detail. The transmitting/receiving unit 51 of the resource management server 5 illustrated in FIG. 4 is mainly implemented by the processing by the CPU 501, the external device connection I/F 507, and the network I/F 509 illustrated in FIG. 2, and transmits and receives various kinds of information to and from the resource management server 5.

The acquiring unit 52 is mainly implemented by the processing by the CPU 501 illustrated in FIG. 2, and registers the authentication information (user ID and password, administrator ID and password) transmitted from the reception terminal 8 and the PC 6 in the login information table configuring the login information DB 5001.

The clock unit 53 is mainly implemented by the processing by the CPU 501 illustrated in FIG. 2, and manages the time information within the resource management server 5.

The determining unit 55 is mainly implemented by the processing by the CPU 501 illustrated in FIG. 2, and performs various determinations in the resource management server 5.

The communication unit 58 is mainly implemented by the processing by the CPU 501, the external device connection I/F 507, and the network I/F 509 illustrated in FIG. 2. The communication unit 58 mainly communicates with the reservation management server 4 and other devices.

The storage/reading processing unit 59 is mainly implemented by the processing by the CPU 501 illustrated in FIG. 2, and stores various kinds of data (or information) in the storage unit 5000 or reads various kinds of data (or information) from the storage unit 5000.

### <Functional Configuration of PC>

As illustrated in FIG. 4, the PC 6 includes a transmitting/receiving unit 61, an accepting unit 62, a display control unit 64, a communication unit 68, and a storage/reading processing unit 69. Each of these functional units is a function or means that is implemented by operating any of the elements illustrated in FIG. 2 by an instruction from the CPU 601 according to a program for the PC 6 loaded in the RAM 603 from at least one of the ROM 602 or the HD 604. The PC 6 includes a storage unit 6000 configured by the ROM 602 or the HD 604 illustrated in FIG. 2.

### <<Each Functional Configuration of PC>>

Next, each functional configuration of the PC 6 will be described in detail. The transmitting/receiving unit 61 of the PC 6 illustrated in FIG. 4 is mainly implemented by the processing by the CPU 601, the external device connection I/F 607, and the network I/F 609 illustrated in FIG. 2, and transmits and receives various kinds of information with the resource management server 5 via the communication network 100. According to the present embodiment, various kinds of information (data) such as information on the reservation of various resources, the resource reservation status of a user who uses the resource, an action schedule, and the like, are transmitted to and received from the resource management server 5.

The accepting unit 62 is mainly implemented by processing by the CPU 601, the keyboard 610, and the pointing device 611 illustrated in FIG. 2, and accepts various selections or inputs from the administrator. Alternatively, other input means, such as a touch panel, may be used.

The display control unit 64 is mainly implemented by the processing by the CPU 601 and the display 606 illustrated in FIG. 2, and displays, for example, text and images generated according to various kinds of data transmitted from the resource management server 5.

The communication unit 68 is mainly implemented by the processing by the CPU 601, the external device connection I/F 607, and the network I/F 609 illustrated in FIG. 2, and is a circuit for communicating with terminals such as the reception terminal 8 and various devices via the communication network 100 configured inside the firewall 105. Although the communication unit 68 and the transmitting/receiving unit 61 are configured to include separate communication units, a communication unit may be shared.

The storage/reading processing unit 69 is mainly implemented by the processing by the CPU 601 illustrated in FIG. 2, and performs processing for storing various kinds of data in the storage unit 6000 and reading various kinds of data stored in the storage unit 6000.

### <Functional Configuration of Reception Terminal>

As illustrated in FIG. 4, the reception terminal 8 includes a transmitting/receiving unit 81, an accepting unit 82, a display control unit 84, a terminal authenticating unit 86, and a storage/reading processing unit 89. Each of these units is a function or means that is implemented by operating any of the elements illustrated in FIG. 3 by an instruction from the CPU 701 according to a program for the reception terminal 8 loaded in the RAM 703 from at least one of the ROM 702 or the EEPROM 704.

The reception terminal 8 includes a storage unit 8000 that is configured by the ROM 702 or the EEPROM 704 illustrated in FIG. 3.

### (Mark Management Table)

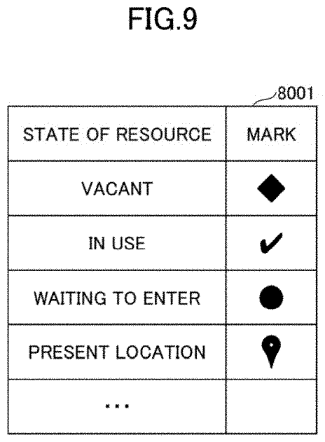

FIG. 9 is a conceptual diagram illustrating an example of a mark management table. A mark management DB 8001 configured with a mark management table such as that illustrated in FIG. 9 is configured in the storage unit 8000. In this mark management table, marks are stored and managed in association with each resource state.

The state of a resource may be, for example, “vacant”, “in use”, “waiting to enter”, or “present location”. However, the “present location” is managed as an item indicating the location where the reception terminal 8 is installed. The marks may include, for example, “a diamond shaped mark”, “a tick mark”, “a circular mark”, and “a present location symbol”. As the state of a resource, various forms may be applied depending on the type of the target resource. For example, in the case of a shared vehicle such as a rental car, the state of the resource may be, for example, “on loan”, “available for use”, “under maintenance”, “refueling”, or the like.

### <<Each Functional Configuration of Reception Terminal>>

Next, each functional configuration of the reception terminal 8 will be described in detail. The transmitting/receiving unit 81 of the reception terminal 8 illustrated in FIG. 4 is mainly implemented by the processing by the CPU 701, the long range communication circuit 712, and the external device connection I/F 719 illustrated in FIG. 3, and transmits and receives various kinds of data (or information) with the reservation management server 4 and the resource management server 5 via the communication network 100.

The accepting unit 82 is mainly implemented by the processing by the CPU 701 and the touch panel 721 illustrated in FIG. 3, and accepts various selections or inputs from a user. In addition to the touch panel 721, an operation button or the like may be used as another input means.

The display control unit 84 is mainly implemented by the processing by the CPU 701 and the display 718 illustrated in FIG. 3, and performs control for displaying various images, characters, code information, and the like on the display 718. The display control unit 84 also controls the switching process of various images, characters, code information, or the like

The terminal authenticating unit 86 is mainly implemented by the processing by the CPU 701 illustrated in FIG. 3. For example, the terminal authenticating unit 86 authenticates the login to the terminal application based on whether the input password is correct.

The storage/reading processing unit 89 is mainly implemented by the processing by the CPU 701 illustrated in FIG. 3. The storage/reading processing unit 89 stores various kinds of data (or information) in the storage unit 8000 or reads various kinds of data (or information) from the storage unit 8000.

### [Processing or Operation According to Embodiment]

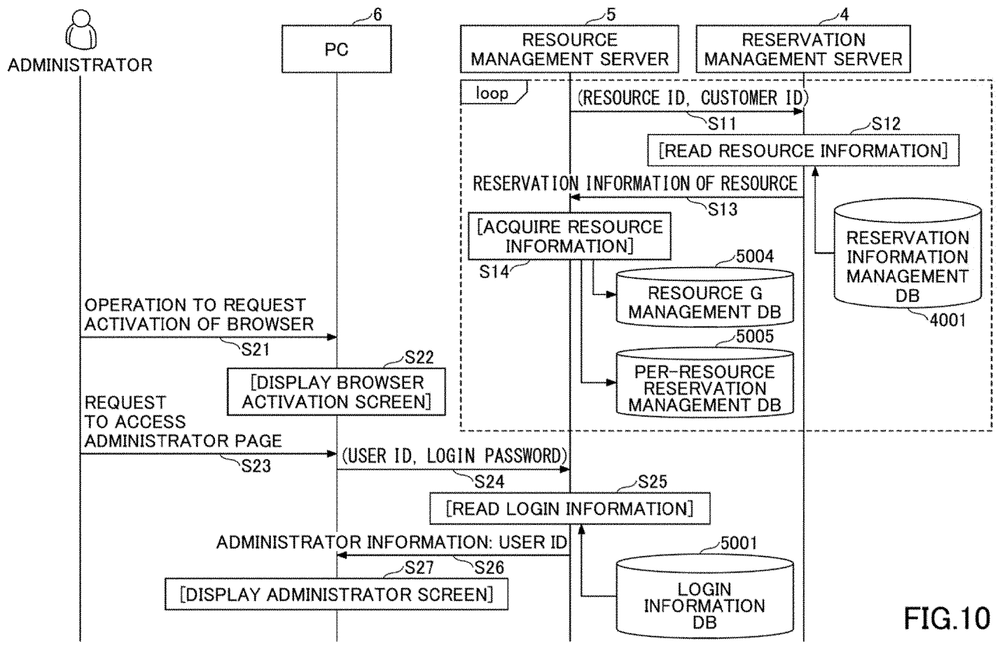

Next, the processing or operation in the resource management system 1 according to the present embodiment will be described with reference to FIGS. 10 to 22.

### <<Coordination Registration Process of Conference Room Map>

First, the registration process of a conference room map will be described with reference to FIG. 10. FIG. 10 is a sequence diagram illustrating an example of an activation process in the coordination registration of a conference room map.

### <<Acquire Conference Room Information>>

First, in step S11, the transmitting/receiving unit 51 of the resource management server 5 transmits a resource information acquisition request including a resource ID and a customer ID to the reservation management server 4. Therefore, the transmitting/receiving unit 41 of the reservation management server 4 receives the resource information acquisition request including the resource ID and the customer ID transmitted by the resource management server 5.

Subsequently, in step S12, the storage/reading processing unit 49 of the reservation management server 4 reads the reservation information of the corresponding conference room by searching the reservation information management table (see FIG. 5) by using the resource ID received by the transmitting/receiving unit 41 as the search key. Further, the storage/reading processing unit 49 reads the corresponding information by searching the data table stored and managed in the reservation management server 4 by using the customer ID as the search key.

Subsequently, in step S13, the transmitting/receiving unit 41 transmits the reservation information of the resource to the resource management server 5 as a response to the resource information acquisition request. Therefore, the transmitting/receiving unit 51 of the resource management server 5 receives the reservation information of the resource transmitted by the transmitting/receiving unit 41 of the reservation management server 4. The reservation information for this resource includes, for example, the reservation person account, the start date and time and the end date and time of the event to be held in the conference room that is the resource, and the expected participant account.

Subsequently, in step S14, the storage/reading processing unit 59 of the resource management server 5 registers the reservation information received by the transmitting/receiving unit 51 in the resource group management table constructing the resource group management DB 5004 and the per-resource reservation management table constructing the per-resource reservation management DB 5005. Accordingly, the acquired information related to each conference room is registered and managed in the resource group management DB 5004 and the per-resource reservation management DB 5005. The information in the conference room does not change frequently, and, therefore, the information is to be acquired at a low frequency, such as once a day. The acquiring unit 52 may acquire the reservation information from the reservation management server 4 periodically or when the reservation information is updated.

In the resource management system 1 according to the present embodiment, when the above-described processing of step S11 and step S13 is performed, other devices or the like may exist between the resource management server 5 (resource management apparatus) and the reservation management server 4 (reservation management apparatus). That is, each piece of information that is transmitted and received between the resource management server 5 and the reservation management server 4 may be configured to be transmitted and received via another device once. The above-described configurations and processing methods can be applied to other processing steps below.

### <<Browser Activation Process>>

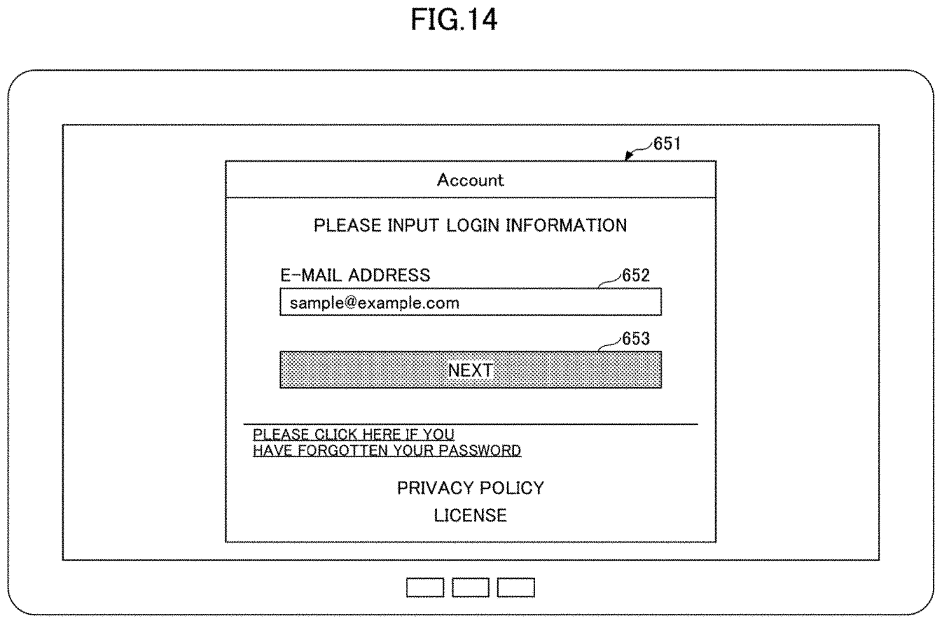

Subsequently, in step S21, the accepting unit 62 of the PC 6 accepts a browser activation request according to an operation by an administrator. For example, the administrator who makes an initial setting in the reception terminal 8 activates the browser of the PC 6 (may be an exclusive-use application) and performs an operation to log in to the resource management server 5. For example, the user ID and password are used as authentication information. Here, it is assumed that the authentication is successful. This allows the PC 6 to display an initial screen. An example of a login screen is illustrated in FIG. 14 as a screen example.

After accepting the input of the authentication information, the display control unit 64 displays a browser activation screen (for example, a login screen 651) on the display 606 of the PC 6 (step S22).

The administrator who has confirmed the browser activation screen in step S22 accesses the administrator page (administrator page access request). In step S23, the accepting unit 62 of the PC 6 accepts an access request according to an operation by the administrator.

After accepting the access request in step S23, in step S24, the transmitting/receiving unit 61 transmits the administrator information access request to the resource management server 5, by using, for example, a general individual authentication system. Therefore, the transmitting/receiving unit 51 of the resource management server 5 receives the administrator information access request transmitted from the PC 6. The administrator information access request includes the administrator's user ID (e.g., e-mail address) and login password.

Subsequently, in step S25, the storage/reading processing unit 59 of the resource management server 5 reads the corresponding user ID and login password by searching the login information table (see FIG. 6A) by using the received user ID or login password as a search key, as a process of reading the login information.

When user authentication is successful, in step S26, the transmitting/receiving unit 51 transmits the administrator information access response including the administrator's user ID to the PC 6. Therefore, the transmitting/receiving unit 61 of the PC 6 receives the administrator information access response including the administrator's user ID transmitted from the resource management server 5.

In the resource management system 1 according to the present embodiment, when the above-described processing of step S24 and step S26 is performed, other devices or the like may exist between the resource management server 5 (resource management apparatus) and the PC 6 (terminal for an administrator). That is, each piece of information that is transmitted and received between the resource management server 5 and the PC 6 may be configured to be transmitted and received via another device once. The above-described configurations and processing methods can be applied to other processing steps below.

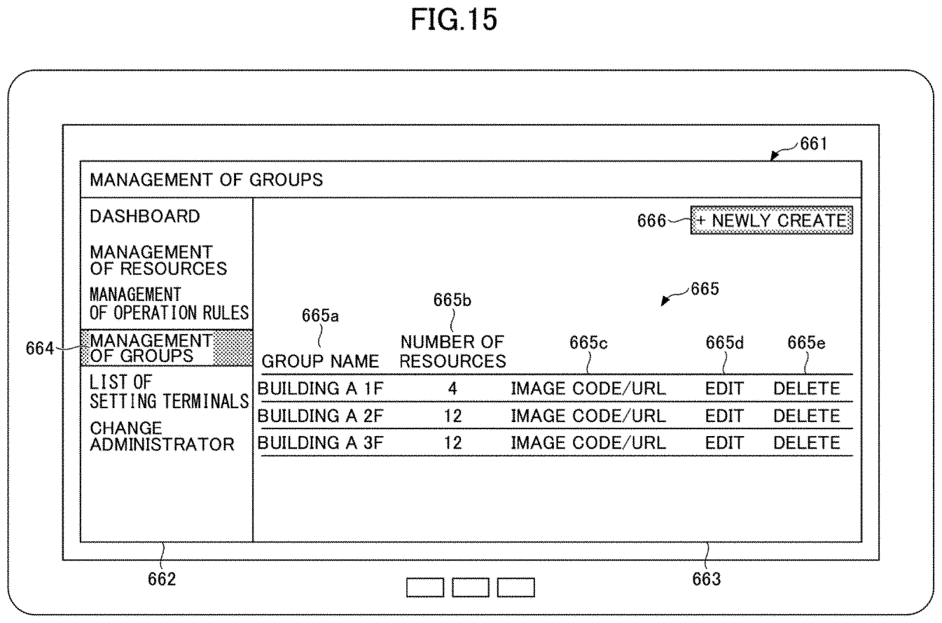

Subsequently, in step S27, the display control unit 64 of the PC 6 that has received the administrator information access response displays the management screen (for example, a group list screen 661 as illustrated in FIG. 15) on the display 606.

### <<Registration Process of Conference Room Map>>

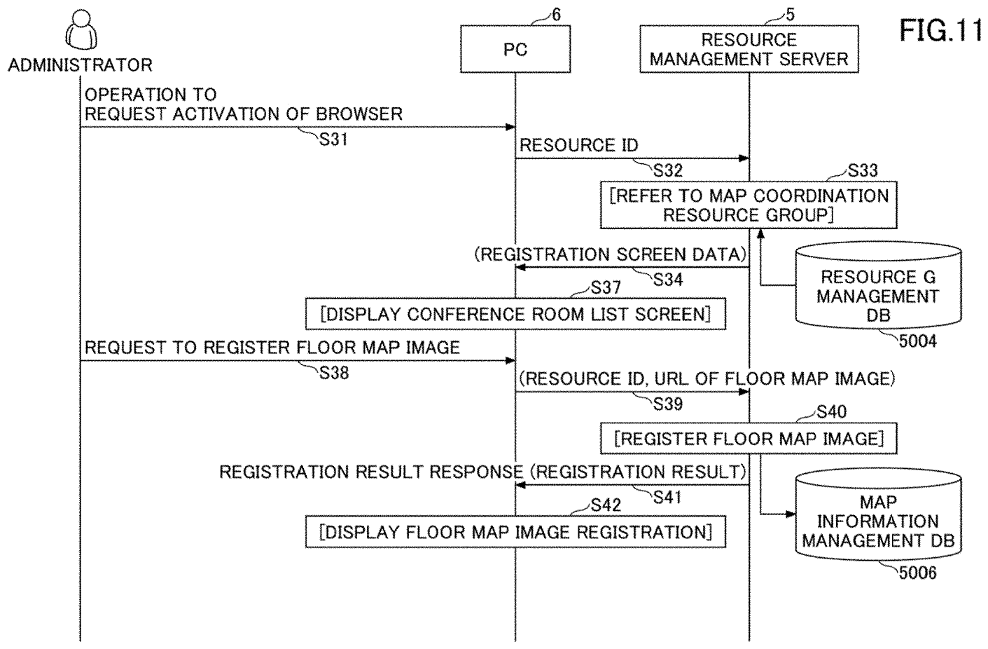

Next, a sequence diagram of FIG. 11 will be described. FIG. 11 is a sequence diagram illustrating an example of floor map image registration in coordination registration of a conference room map. The administrator who has confirmed that the management screen is displayed on the display 606 of the PC 6, performs an operation such as clicking or tapping an edit button 665d corresponding to the group name (e.g., Building A 1F) to select the resource group (map coordination resource group information request) in the screen displayed in FIG. 15. In step S31, the accepting unit 62 of the PC 6 accepts the processing according to the operation by the administrator.

Subsequently, in step S32, the transmitting/receiving unit 61 transmits the map coordination resource group information request including the resource ID to the resource management server 5. Accordingly, the transmitting/receiving unit 51 of the resource management server 5 receives the map coordination resource group information request including the resource ID transmitted from the PC 6.

After receiving the map coordination resource group information request including the resource ID, the storage/reading processing unit 59 of the resource management server 5 reads the corresponding resource name or the like by searching the resource group management table (see FIG. 7) by using the received resource ID as the search key (step S33).

After the processing in step S33, in step S34, the transmitting/receiving unit 51 transmits an information request response including the registration screen data to be displayed to the PC 6. Therefore, the transmitting/receiving unit 61 of the PC 6 receives the information request response including the registration screen data transmitted from the resource management server 5.

Subsequently, in step S37, the display control unit 64 displays, on the display 606 of the PC 6, for example, a screen in which a group is added to the group management screen illustrated in FIG. 15.

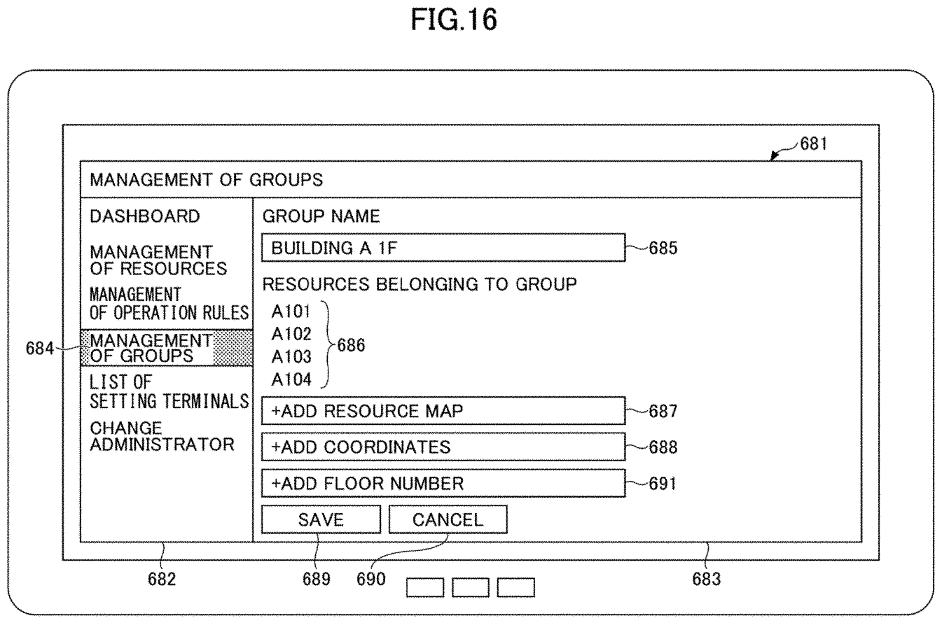

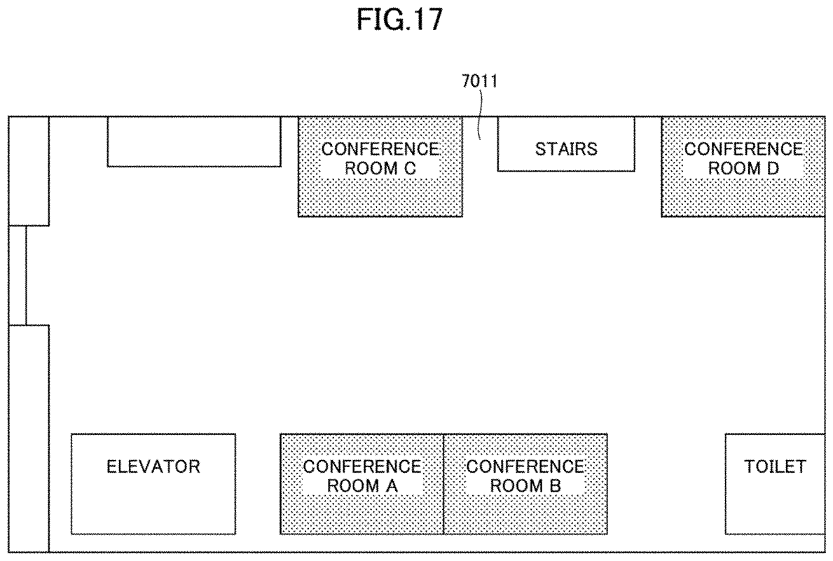

Subsequently, the administrator performs an upload operation to register the floor map image. The screen to be operated is pressed, clicked, tapped, or the like, on the “+ add resource map” button 687 in FIG. 16, which will be described later. Accordingly, in step S38, the accepting unit 62 of the PC 6 accepts an operation from the administrator to the “+ add resource map” button 687. The floor map image registered here is, for example, an image as illustrated in FIG. 17, which will be described later.

According to the processing in step S38, in step S39, the transmitting/receiving unit 61 transmits, to the resource management server 5, a request including the resource ID and the URL where the floor map image is to be uploaded as the floor map image registration request. Therefore, the transmitting/receiving unit 51 of the resource management server 5 receives the request including the resource ID and the URL of the upload destination of the floor map image transmitted from the PC 6.

When the request including the ID and the URL of the upload destination of the floor map image is received from the PC 6, the storage/reading processing unit 59 of the resource management server 5 stores the resource ID and the map image file (URL) of the conference room as illustrated in FIG. 17 in association with the map information management table (see FIG. 8B) (step S40). In the present embodiment, storing the resource ID and the upload destination of the floor map image data in the storage unit 5000 in association with each other, may be expressed as registering the map image file, storing the map image file as a part of the map information in the storage unit 5000, or the like.

Subsequently, in step S41, the transmitting/receiving unit 51 transmits the registration result response to the PC 6. Therefore, the transmitting/receiving unit 61 of the PC 6 receives the registration result response transmitted from the resource management server 5.

Upon receiving the registration result response from the resource management server 5, the display control unit 64 of the PC 6 displays the group registration screen, as illustrated in FIG. 16, which will be described later, on the display 606 of the PC 6 (step S42).

### <<Process of Registering Resource Position in Conference Room Map>>

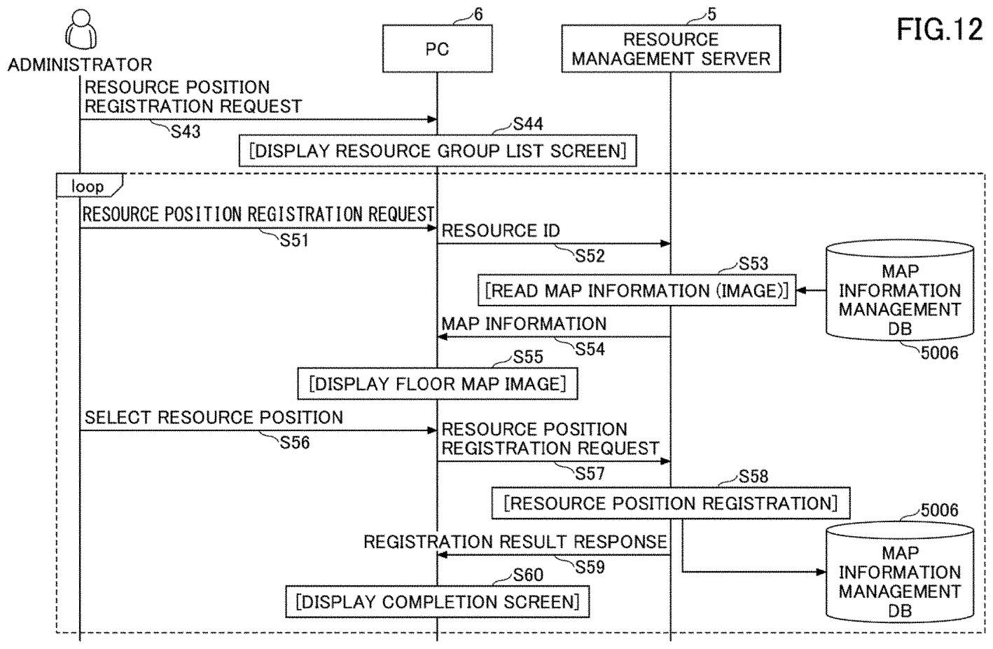

Next, a sequence diagram of FIG. 12 will be described. FIG. 12 is a sequence diagram illustrating an example of the resource position registration in the coordination registration in the conference room map. The administrator who has confirmed the group registration screen performs the processing of selecting a resource position registration menu by an operation of pressing, clicking, tapping, or the like of an “+ add coordinates” button 688 as illustrated in FIG. 16, to request resource position registration. Accordingly, in step S43, the accepting unit 62 of the PC 6 accepts an operation with respect to the “+ add coordinates” button 688.

In step S44, the PC 6 that has accepted the resource position registration request displays a screen of a list of conference rooms belonging to the group as a resource group list screen on the display 606.

Subsequently, the administrator selects the resource position registration menu from the browser menu. Specifically, the administrator selects one of the resources from a resource list 686 in the “resources belonging to group” column illustrated in FIG. 16 (resource position registration request). Therefore, in step S51, the accepting unit 62 of the PC 6 accepts the resource selected by the administrator among the “resources belonging to group”.

Subsequently, in step S52, the transmitting/receiving unit 61 transmits the map information acquisition request including the resource ID as the request information to the resource management server 5. Therefore, the transmitting/receiving unit 51 of the resource management server 5 receives the map information acquisition request including the resource ID as the request information transmitted from the PC 6.

When the map information acquisition request including the resource ID as the request information is received, in step S53, the storage/reading processing unit 59 reads the corresponding map image file by searching the map information management table (see FIG. 8B) by using the resource ID as the search key.

After the processing in step S53, in step S54, the transmitting/receiving unit 51 transmits the map image file and the map information including the respective coordinates in the X-axis direction and the Y-axis direction read from the map information management table, to the PC 6, as the map information acquisition response. Therefore, the transmitting/receiving unit 61 of the PC 6 receives the map information response indicated by the map information transmitted from the resource management server 5.

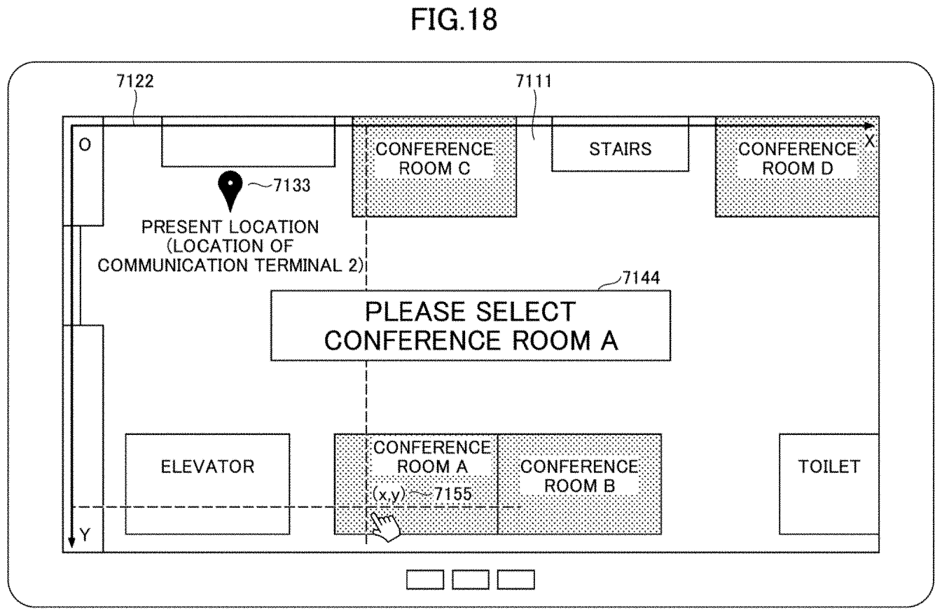

After the processing of step S54 is performed, the display control unit 64 of the PC 6 displays a floor map image (e.g., an image configured by a PDF file) on the display 606, for example, as illustrated in FIG. 18 (step S55). This floor map image will be described in detail in the screen example to be described later.

Subsequently, the administrator performs an operation of pressing, clicking, tapping, or the like, on any position in the conference room A, for example, according to a message of “please select conference room A” displayed on the floor map image on the display 606, as illustrated in FIG. 18. In step S56, the accepting unit 62 accepts the operation of resource position selection performed by the administrator.

When the operation of step S56 is accepted by the accepting unit 62, in step S57, the transmitting/receiving unit 61 transmits the resource position registration request to the resource management server 5. Therefore, the transmitting/receiving unit 51 of the resource management server 5 receives the resource position registration request transmitted from the PC 6. At this time, the resource position registration request includes information of the absolute coordinates (x, y) with respect to the floor map image provided by the operation by the administrator on the display 606. That is, the transmitting/receiving unit 61 transmits information for registering the image of the conference room A in the floor map image displayed on the display 606 and the absolute coordinates indicating and the position of the conference room A, to the resource management server 5.

When the resource position registration request transmitted from the PC 6 is received, the storage/reading processing unit 59 of the resource management server 5 writes the information of the absolute coordinates (x, y) received in step S57 in the respective coordinate columns in the X-axis direction and the Y-axis direction in the map image file corresponding to the resource ID received in step S52 (step S58).

After the processing in step S58, in step S59, the transmitting/receiving unit 51 transmits information indicating the registration result (text information or the like) to the PC 6 as the registration result response. Accordingly, the transmitting/receiving unit 61 of the PC 6 receives information indicating the registration result transmitted from the resource management server 5 (text information or the like).

After the processing in step S59, the display control unit 64 displays the group registration screen, for example, as illustrated in FIG. 16, on the display 606 (step S60).

The above-described processing from step S51 to step S60 as the registration process of the resource position in the conference room map is repeated by the number of resources (conference rooms) for which position information (coordinates) is to be registered.

Note that the processing from step S51 to step S60 is an example, and the contents, the sequence, and the like, of each processing executed in the resource management system 1 are not limited, within a scope not deviating from the gist of the present invention.

### <<Registration Process of Resource Position in Conference Room Map>>

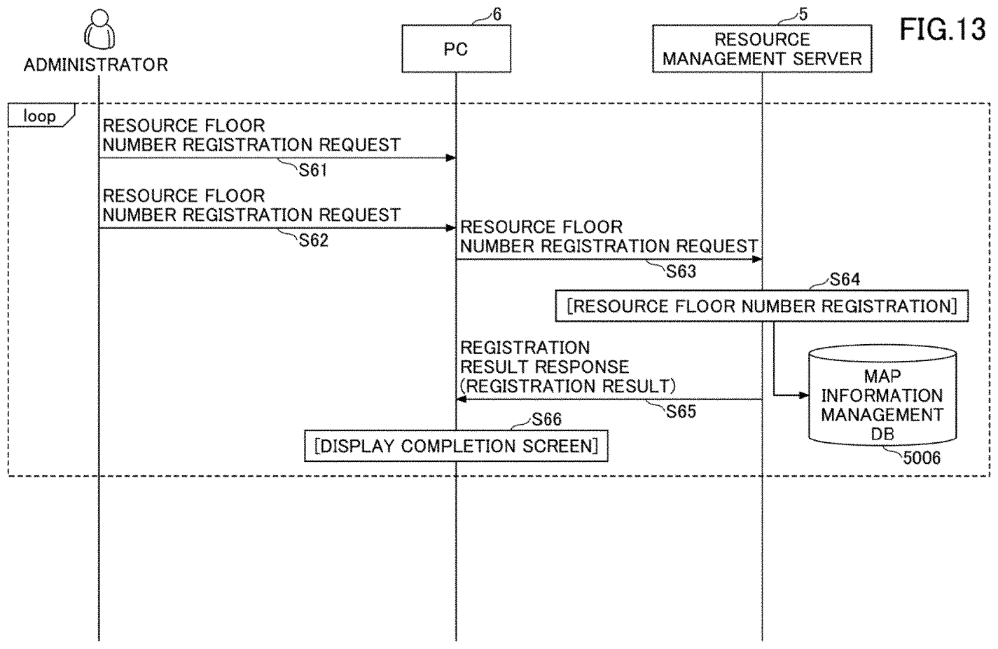

Next, a sequence diagram of FIG. 13 will be described. FIG. 13 is a sequence diagram illustrating an example of resource floor number registration in coordination registration of a conference room map. The administrator who has confirmed the group registration screen performs the processing of selecting the resource floor number registration menu by an operation of pressing, clicking, tapping, or the like, on an “+ add floor number” button 691 as illustrated in FIG. 16, and requests resource floor number registration. Accordingly, in step S61, the accepting unit 62 of the PC 6 accepts an operation with respect to the “+ add floor number” button 691.

In step S62, the PC 6 that has accepted the resource position registration request displays a screen for accepting input of the floor number of the floor map registered in the resource group on the display 606, and the accepting unit 62 accepts an operation of inputting the floor number on the screen by the administrator.

When the operation of step S62 is accepted by the accepting unit 62, in step S63, the transmitting/receiving unit 61 transmits the resource floor number registration request to the resource management server 5. The resource floor number registration request is also referred to as an area registration request. Therefore, the transmitting/receiving unit 51 of the resource management server 5 receives the resource floor number registration request transmitted from the PC 6. At this time, the resource floor number registration request includes the information (area information) of the floor number with respect to the floor map image provided by the operation by the administrator on the display 606. That is, the transmitting/receiving unit 61 transmits information for registering the floor number to which each conference room belongs in the floor map image displayed on the display 606, to the resource management server 5.

When the resource floor number registration request transmitted from the PC 6 is received, the storage/reading processing unit 59 of the resource management server 5 writes the information of the floor number received in step S63 in each floor number field of the resource corresponding to the map image file received in step S39 (step S64). That is, the storage/reading processing unit 59 of the resource management server 5 stores the area information as a part of the map information in the map information management DB 5006.

After the processing in step S64, in step S65, the transmitting/receiving unit 51 transmits information indicating the registration result (text information or the like) to the PC 6 as the registration result response. Accordingly, the transmitting/receiving unit 61 of the PC 6 receives information indicating the registration result transmitted from the resource management server 5 (text information or the like).

After the processing in step S65, the display control unit 64 displays the group registration screen, for example, illustrated in FIG. 16, on the display 606 (step S60).

As described above, the processing of steps S61 to S66 as the resource floor number registration process in the conference room map is repeated by the number of resource groups for which the floor number information is to be registered.

Further, at the same time as floor number information is registered, a guidance message may be registered. The guidance message differs depending on whether the floor number is where the reception terminal is installed. The following are examples of the guidance message: “ride the escalator to the second floor”; “the conference room to be used is on the floor where you are presently located”. The guidance message is not limited to these examples, as long as the message is for identifying the floor number where the conference room is located.

The processing of steps S61 to S66 is an example, and the contents, the sequence, and the like, of each processing performed in the resource management system 1 are not limited, within a scope not deviating from the gist of the present invention.

### (Examples of Screens)

FIG. 14 is a diagram illustrating an example of a login screen at the time of activation. As illustrated in FIG. 14, when the above-described processing of step S22 is performed, the login screen 651 is displayed on the display 606 of the PC 6 by the display control unit 64. The login screen 651 displays an “e-mail address” input field 652 and a “next” button 653. This allows the administrator to make the administrator page access request described in step S23.

FIG. 15 is a diagram illustrating an example of a group management screen. As illustrated in FIG. 15, when the above-described processing of step S27 is performed, the group list screen 661 is displayed on the display 606 of the PC 6 by the display control unit 64. The group list screen 661 includes a menu field 662 and a group display field 663. Further, a group management button 664 is included in the menu field 662. Further, the group display field 663 includes a group name 665a, a number of resources 665b, an image code/URL 665c, an edit button 665d, and a delete button 665e, as a group list 665. Further, the group display field 663 includes a newly create button 666.

FIG. 16 is a diagram illustrating an example of a group registration screen. As illustrated in FIG. 16, when the above-described processing of steps S37, S42, or S60 is performed, a group registration screen 681 is displayed on the display 606 of the PC 6 by the display control unit 64. The group registration screen 681 includes a menu field 682 and a selection resource display field 683. The menu field 682 includes a management of groups button 684. Further, the selection resource display field 683 includes a group name input field 685, a resource list 686, an “+ add resource map” button 687, an “+ add coordinates” button 688, a save button 689, a cancel button 690, and an “+ add floor number” button 691.

FIG. 17 is a diagram illustrating an example of a floor map for registration. As illustrated in FIG. 17, in a floor map image 7011, conference rooms A, B, C, and D as resources, as well as a toilet and an elevator, are located at respective positions.

FIG. 18 is a diagram illustrating an example of coordinate setting on a floor map. As illustrated in FIG. 18, when the above-described processing of step S55 is performed, a registration floor map image 7111 is displayed on the display 606 of the PC 6 by the display control unit 64. The registration floor map image 7111 displays X-Y coordinates 7122 in which the X axis is in the horizontal direction and the Y axis is in the vertical direction, using the top left corner of the map image represented by a rectangle, as the origin O.

The scale marks of the X-Y coordinates are represented by pixels ([px]), for example, as illustrated in the map information management table of FIG. 8B. Further, in the X-Y coordinates, coordinates (x, y) 7155 are rendered in the conference room A. The coordinates (x, y) 7155 are provided by an operation by an administrator, for example, by performing the above-described processing in step S43 and step S56.

Further, in FIG. 18, the registration floor map image 7111 displays a present location symbol 7133 indicating the present location, together with the resources. Further, near the center of the registration floor map image 7111, a “please select conference room A” message 7144 is displayed for prompting the selection of a resource (conference rooms) to provide coordinates as location information. In the present embodiment, the message prompting the selection of conference room A is displayed, but a message prompting the selection of any of the other conference rooms B, C, and D may be displayed.

### <Process of Displaying Conference Room Map>

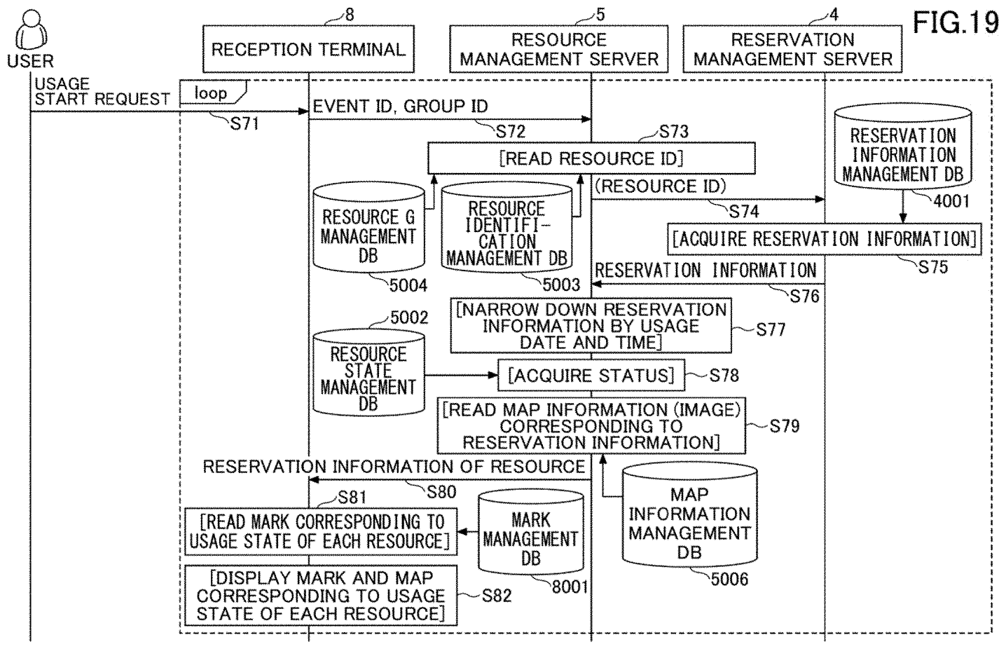

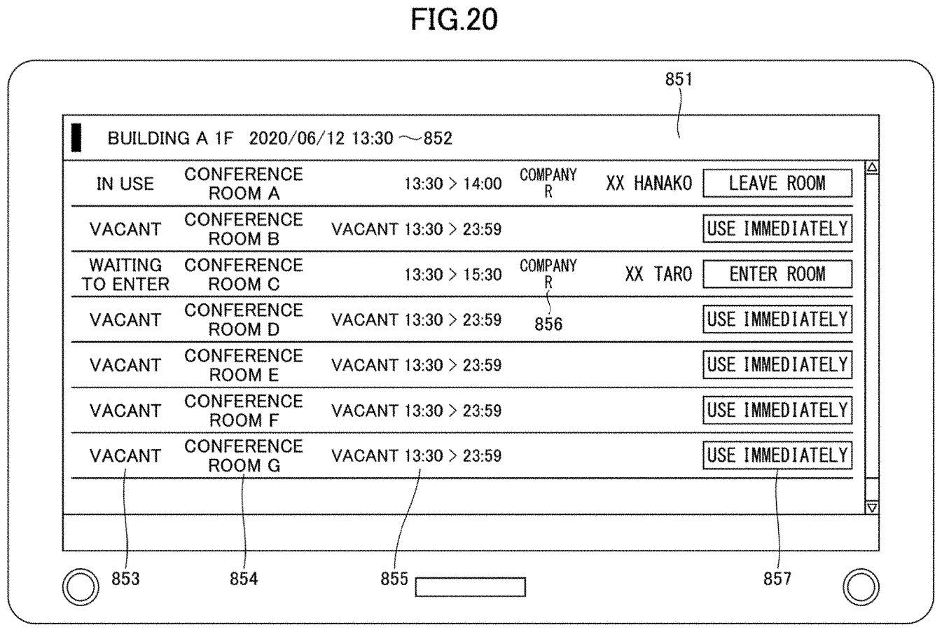

FIG. 19 is a sequence diagram illustrating an example of a floor map display on the reception terminal. As illustrated in FIG. 19, first, the user of the conference room, which is an example of a resource, makes a request to start using a conference room (check in), with respect to the reception terminal 8 installed on the floor, which includes the conference room (e.g., the conference room C) scheduled to be used or the conference room (e.g., conference room E) that can be used immediately. The display control unit 84 displays a list of reservation statuses of each resource, for example, as illustrated in FIG. 20.

The display mode of FIG. 20 will be described in detail with reference to the screen example described below. For example, to make the usage start request, the user specifies the conference room C by using the User Interface (UI) unit of the reception terminal 8 and inputs information indicating the start of use (check-in). At this time, for example, the user performs an operation of pressing, clicking, tapping, or the like, on “enter room” of the resource reserved by the user (for example, the conference room C). Accordingly, the reception terminal 8 displays the input screen of the event ID, so that the user can input the event ID and make a usage start request.

Here, when the conference room E, which can be immediately used but has not been reserved, is specified, by an operation of pressing, clicking, tapping, or the like, on “use immediately”, an event ID is automatically generated and a usage start request is made (step S71). At this time, the identification information (resource ID) of the conference room that is scheduled to be used or that is specified, is also provided to the reception terminal 8, by processing by the user. First, with the group ID, first, a process is performed to associate the customer with each resource (each conference room) for each reception terminal, and by this association process, the reception terminal 8 and the group ID of each conference room are associated with each other.

Next, in step S72, the transmitting/receiving unit 81 of the reception terminal 8 transmits the event ID and the group ID input by the user to the resource management server 5 in order to receive the map information indicating the position of each resource, the usage state of each resource, and the reservation information relating to each resource. Therefore, the transmitting/receiving unit 51 of the resource management server 5 receives the event ID and the group ID transmitted from the reception terminal 8.

Subsequently, the storage/reading processing unit 59 of the resource management server 5 reads the corresponding resource ID by searching the resource group management table (see FIG. 7) by using the group ID received by the transmitting/receiving unit 51 as the search key. However, at this stage, there may be multiple resource IDs that are read. Accordingly, in step S73, the storage/reading processing unit 59 reads the corresponding resource ID by searching the resource identification management table (see FIG. 6C) by using the event ID as the search key. In the present embodiment, the resource group management DB 5004 configured by the resource group management table and the resource identification management DB 5003 configured by the resource identification management table may function as a resource management unit.

Next, in step S74, the transmitting/receiving unit 51 transmits a request to acquire the reservation information to the reservation management server 4. Therefore, the transmitting/receiving unit 41 of the reservation management server 4 receives the reservation information acquisition request transmitted from the resource management server 5. The reservation information acquisition request includes the resource ID read in step S73.

In step S75, the storage/reading processing unit 49 reads the corresponding reservation information (the reservation ID, the reservation person account, the start date and time, the end date and time, and the expected participant account) by searching the reservation information management table (see FIG. 5) by using the resource ID received by the transmitting/receiving unit 41 as the search key.

Subsequently, in step S76, the transmitting/receiving unit 41 transmits the reservation information read by the storage/reading processing unit 49 to the resource management server 5, as a response to the reservation information acquisition request. Accordingly, the transmitting/receiving unit 51 of the resource management server 5 receives a response to the reservation information acquisition request transmitted from the reservation management server 4.

Upon receiving the response to the reservation information acquisition request transmitted from the reservation management server 4, the determining unit 55 of the resource management server 5 acquires the current time from the clock unit 53. Thereafter, the determining unit 55 narrows down the acquired reservation information by the usage date and time. That is, in step S77, the determining unit 55 determines whether each piece of information of the start date and time and the end date and time included in the received reservation information includes the current time, and narrows down the reservation information to that of a reservation person account that satisfies this condition. That is, the determining unit 55 determines whether the acquired current time is included between the start date and time and the end date and time included in the received reservation information and narrows down the reservation information to that of a reservation person account that satisfies this condition.

In step S78, the storage/reading processing unit 59 reads the reservation state of the corresponding resource by searching the resource state management table (see FIG. 6B) by using the reservation person account, identified by the narrowing down processing in step S77, as the search key. That is, the storage/reading processing unit 59 acquires the status of the corresponding resource.

In step S79, the storage/reading processing unit 59 reads the corresponding map image file (URL) by searching the map information management table (see FIG. 8B) by using the resource ID read in step S73 as the search key.

Subsequently, in step S80, the transmitting/receiving unit 51 transmits the map image file (URL) indicating the map information read in step S79, the status of resource (the usage state), and the reservation information to the reception terminal 8. Accordingly, the transmitting/receiving unit 81 of the reception terminal 8 receives the map image file (URL) indicating the map information, the status of the resource (the usage state), and the reservation information transmitted from the resource management server 5.

In the resource management system 1 according to the present embodiment, when the above-described processing of step S72 and step S80 is performed, other devices may exist between the resource management server 5 (resource management apparatus) and the reception terminal 8 (communication terminal). That is, each piece of information transmitted and received between the resource management server 5 and the reception terminal 8 may be configured to be transmitted and received once via another device.

When the map image file (URL) indicating the map information, the status of the resource (the usage state), and the reservation information are received by the transmitting/receiving unit 81, in step S81, the storage/reading processing unit 89 reads the corresponding mark by searching the mark management table (see FIG. 9) by using the resource status (i.e., the state of the resource) as the search key.

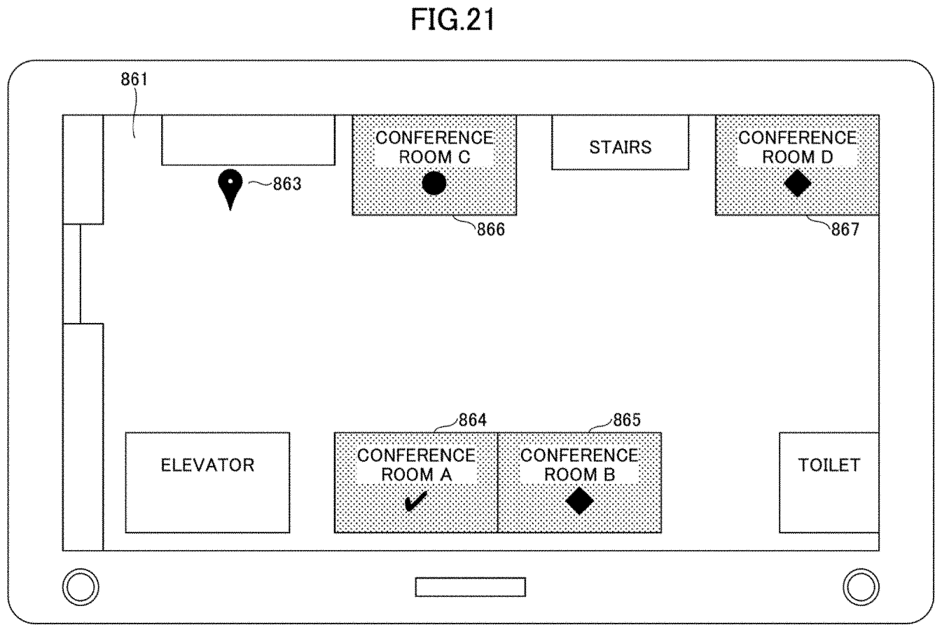

After the processing in step S81, the display control unit 84 combines (superimposes on) a mark corresponding to the usage state of each resource with each resource and displays the mark superimposed on the resource as illustrated in FIG. 21 (step S82). The display mode of FIG. 21 will be described in detail with reference to the screen example described below. Here, the transition from the screen of FIG. 20 to the screen of FIG. 21 is performed by the user's usage start request, but a method of switching the screen at predetermined time intervals set in advance or at predetermined time intervals set by the administrator may be performed. Further, the screen of FIGS. 20 and 21 may be provided with a “switch button”, so that the screens are alternately displayed by the user's operation.

Note that the processing of steps S71 to S82 is an example, and the contents, the sequence, and the like, of each processing executed in the resource management system 1 are not limited, within a scope not deviating from the gist of the present invention.

### (Example of Screen)

FIG. 20 is a diagram illustrating an example of a resource list display screen. As illustrated in FIG. 20, a resource list display screen 851 is displayed on the display 718 (display unit) of the reception terminal 8 by the display control unit 84. As described above, in the resource list display screen 851, the user performs an operation of pressing, clicking, tapping, or the like, on “enter room” with respect to the resource reserved by the user (e.g., the conference room C), or performs an operation of pressing, clicking, tapping, or the like, on “use immediately” with respect to the resource that is not reserved but is to be used now (e.g., conference room E), to make a usage start request. The resource list display screen 851 includes a location/date and time display field 852, a usage state display field 853, a resource display field 854, a reservation time display field 855, a customer display field 856, and a customer schedule display field 857. For example, the user can confirm that the conference room A is currently in use by Ms. Hanako XX of Company R. Further, the user can confirm that Mr. Taro XX of Company R is waiting to enter the conference room C. Furthermore, it can be confirmed that conference room B, conference room D, conference room E, conference room F, and conference room G are not reserved for the entire day and can be used immediately.

FIG. 21 is a diagram illustrating an example of a floor map display screen (A) after screen switching. Here, the floor map image displayed when a usage start request is made by specifying the conference room C, will be described. As illustrated in FIG. 21, when the above-described processing in step S82 is performed, a floor map display screen 861 is displayed on the display 718 of the reception terminal 8 by the display control unit 84. The floor map display screen 861 includes a present location 863, a conference room A 864, a conference room B 865, a conference room C 866, and a conference room D 867.

Further, a “tick” mark indicating “in use” is combined with (superimposed on) the conference room A 864. Similarly, a “diamond” mark indicating “vacant” is combined with (superimposed on) the conference room B 865. A “circle” mark indicating “waiting to enter” is combined with (superimposed on) the conference room C 866. A “diamond” mark indicating “vacant” is combined with (superimposed on) the conference room D 867. At this time, if there is a guidance message simultaneously registered at the time of floor number registration, a guidance message may be displayed on the screen. In order to make it easier to identify the position of a resource for which a usage start request has been made, a mark indicating the usage state of a resource, other than the resource for which the usage start request has been made, may not be displayed. That is, only the usage state of the resource for which the usage start request has been made may be displayed.

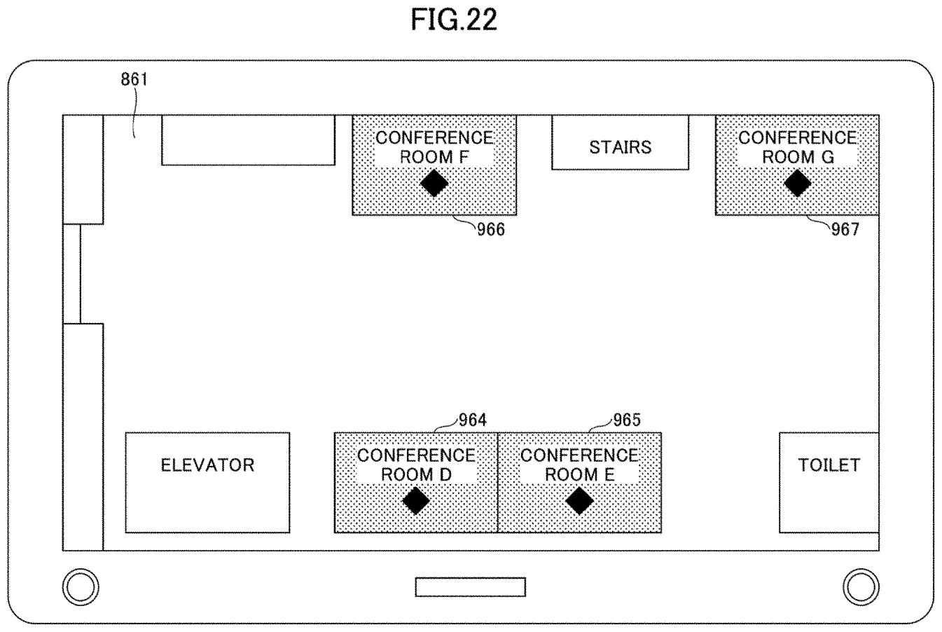

FIG. 22 is a diagram illustrating an example of the floor map display screen (B) after the screen switching. Here, a floor map image displayed when a usage start request is made by specifying the conference room D will be described. As illustrated in FIG. 22, when the above-described processing of step S82 is performed, the floor map display screen 861 is displayed on the display 718 of the reception terminal 8 by the display control unit 84. The floor map display screen 861 includes a conference room D 964, a conference room E 965, a conference room F 966, and a conference room G 967.

Further, a “diamond” mark indicating “vacant” is combined with (superimposed on) the conference room D 964. Similarly, a “diamond” mark indicating “vacant” is combined with (superimposed on) the conference room E 965. A “diamond” mark indicating “vacant” is combined with (superimposed on) the conference room F 966. A “diamond” mark indicating “vacant” is combined with (superimposed on) the conference room G 967. At this time, if there is a guidance message simultaneously registered at the time of floor number registration, a guidance message may be displayed on the screen.

In order to make it easier to identify the position of a resource for which a usage start request has been made, a mark indicating the usage state of a resource, other than the resource for which the usage start request has been made, may be excluded from being displayed. That is, only the usage state of the resource for which the usage start request has been made may be displayed.

As described above, when the reception terminal 8 accepts the usage start request to start using a resource from the user, the map information corresponding to the resource for which the usage start request has been made, is acquired from the resource management server 5, and the reception terminal 8 switches the screen from a screen that displays a list of the usage states of the plurality of resources to a screen that displays the acquired map information. This makes it possible for the user to view the map information of the resource to be used now and easily identify the position of the resource to be used now.

### [Other Applications]

While the preferred embodiment of the invention has been described with reference to embodiments thereof, the present invention is not intended to be limited in any way to the embodiments, and various modifications and substitutions may be made therein without departing from the spirit and scope of the invention.

The resource management system 1 illustrated in the present embodiment may also be referred to as a Web service. Web services are a variety of services provided through the application of Internet-related technologies. For example, web services include conference room rental services and various rental services. A system that uses web services is referred to as a system that uses web services.

The resource management system 1 illustrated in the present embodiment can be further divided into a greater number of processing units depending on the processing contents. Alternatively, one processing unit can be divided to include more processes.

The functions of each of the above-described embodiments can be implemented by one or more processing circuits. Herein, a “processing circuit” includes a processor programmed to perform each function by software, such as a processor implemented by an electronic circuit, a device designed to perform each function as described above, such as an Application Specific Integrated Circuit (ASIC), a digital signal processor (DSP), a field programmable gate array (FPGA), a System on a chip (SOC), a Graphics Processing Unit (GPU), a conventional circuit module, and the like.

According to one embodiment of the present invention, the position of a resource can be easily identified.

The resource management system, the communication terminal, and the recording medium are not limited to the specific embodiments described in the detailed description, and variations and modifications may be made without departing from the spirit and scope of the present invention.

What is claimed is:

1. A resource management system comprising:
a resource management apparatus configured to manage usage of a plurality of resources; and
a communication terminal, wherein
the resource management apparatus includes:
first circuitry; and
a first memory storing computer-executable instructions that cause the first circuitry to execute:
storing, in a storage, map information of an area in which each of the plurality of resources is arranged; and
transmitting, to the communication terminal, the map information of the area associated with a resource for which a usage start request to start using the resource has been made among the plurality of resources, in response to accepting the usage start request from the communication terminal, and wherein
the communication terminal includes:
second circuitry; and
a second memory storing computer-executable instructions that cause the second circuitry to execute:
displaying a screen by switching from a resource list display screen on which state information indicating a usage state of at least one resource among the plurality of resources and reservation information of the at least one resource are displayed, to a map information screen on which the map information of the area associated with the resource for which the usage start request has been made is displayed, the map information being transmitted from the resource management apparatus.

2. The resource management system according to claim 1, wherein
the storing includes storing the state information in the storage,
the transmitting includes transmitting, to the communication terminal, the state information of the at least one resource associated with the map information, in response to accepting the usage start request, and
the displaying includes superimposing the state information transmitted from the resource management apparatus on an image of the at least one resource displayed in the map information.

3. The resource management system according to claim 1, wherein the first circuitry of the resource management apparatus is further caused to execute:
storing, in the storage, a map image as a part of the map information, based on a map image registration request to register the map image, in response to accepting the map image registration request.

4. The resource management system according to claim 3, wherein
the storing includes storing, in the storage, position information of the at least one resource as a part of the map information, based on a position registration request to register a position of the at least one resource, in response to accepting the position registration request.

5. The resource management system according to claim 3, wherein
the storing includes storing, in the storage, area information indicating the area where the at least one resource is arranged as a part of the map information, based on an area registration request to register the area where the at least one resource is arranged, in response to accepting the area registration request.

6. The resource management system according to claim 1, wherein the area is information relating to a floor number.

7. The resource management system according to claim 1, wherein the displaying includes displaying a message relating to the area included in the map information.

8. The resource management system according to claim 2, wherein the displaying includes displaying the map information screen without displaying the usage state of the at least one resource other than the resource for which the usage start request has been made.

9. A communication terminal comprising:
circuitry; and
a memory storing computer-executable instructions that cause the circuitry to execute:
receiving, from a resource management apparatus, map information of an area associated with a resource for which a usage start request to start using the resource has been made, in response to accepting the usage start request; and
displaying a screen by switching from a resource list display screen on which state information indicating a usage state of the resource and reservation information of the resource are displayed, to a map information screen on which the map information of the area associated with the resource for which the usage start request has been made is displayed, the map information being transmitted from the resource management apparatus.

10. A non-transitory computer-readable recording medium storing a program that causes a computer to execute a process performed in a communication terminal, the process comprising:
receiving, from a resource management apparatus, map information of an area associated with a resource for which a usage start request to start using the resource has been made, in response to accepting the usage start request; and
displaying a screen by switching from a resource list display screen on which state information indicating a usage state of the resource and reservation information of the resource are displayed, to a map information screen on which the map information of the area associated with the resource for which the usage start request has been made is displayed, the map information being transmitted from the resource management apparatus.
